(19) United States
(12) Patent Application Publication
(10) Pub. No.: US 2022/0121939 A1
(43) Pub. Date: Apr. 21, 2022

(54) SYSTEMS AND METHODS FOR HIGH-ORDER MODELING OF PREDICTIVE HYPOTHESES

(71) Applicant: THE UNIVERSITY OF CHICAGO, Chicago, IL (US)

(72) Inventors: James Evans, Chicago, IL (US); Feng Shi, Edmonds, WA (US); Jamshid Sourati, Willston (IR)

(21) Appl. No.: 17/451,320

(22) Filed: Oct. 18, 2021

Related U.S. Application Data
(60) Provisional application No. 63/093,142, filed on Oct. 16, 2020.

(51) Int. Cl. G06N 3/08; G06F 17/11; G06N 5/02

(52) U.S. Cl. CPC G06N 3/08; G06N 5/02; G06F 17/11

(57) ABSTRACT

Embodiments disclosed herein receive a corpus of documents associated with a predictive hypothesis. The embodiments may generate a hypergraph comprising a plurality of nodes, the plurality of nodes including content nodes representing content elements from the documents and context nodes representing context elements of the documents, and hyperedges representing each document spanning two or more of the plurality of nodes. This hypergraph may be used to store a predictive hypothesis including a subset of the content elements, each content element of the subset of content elements having a vector representation meeting a predictive hypothesis threshold.

### CROSS REFERENCE TO RELATED APPLICATIONS

This application claims priority to Provisional Patent Application Ser. No. 63/093,142 filed Oct. 16, 2020 and titled “Systems and Methods for High-Order Stochastic Block Modeling,” incorporated by reference herein.

### BACKGROUND

Research across applied science and engineering, from materials discovery to drug and vaccine development, is hampered by enormous design spaces that overwhelm researchers' ability to evaluate the full range of potentially valuable candidate designs. To face this challenge, researchers have initialized data-driven AI models with the contents of published scientific results to create powerful prediction engines that infer future findings. These models are being used in a variety of applications, including enabling discovery of novel materials with desirable properties and targeted construction of new therapies.

Predictions of novelty or breakthrough progress may be informed by past recognitions, such as Nobel Prizes and other awards and certificates conferred by scientific societies. However, these recognitions tend to be biased towards some forms of novelty and away from others. Typical recognized breakthroughs trend toward surprising combinations scientific content within or close to a field of the awarding body. This bias in recognizing breakthroughs may be driven by the tendency of scientists to amplify the familiarity of their work to colleagues, editors and reviewers, increasing their references to familiar sources in order to appear to build on the shoulders of their audience.

Virtually all empirical research examining combinatorial discovery and invention has deconstructed new products into collections of pairwise combinations, resting on mature analysis tools for simple graphs that define links between entity pairs. However, pairwise combinations fail to capture the complexity of most bodies of knowledge, such as clustering in neuronal networks, stabilizing interaction between species or global transportation networks.

A stochastic block model is a type of generative model used for statistical classification, machine learning, and network science. Stochastic block models are typically used to identify community structure in sets of objects that represented in a graph in which pairs of vertices are linked by edges. A mixed membership stochastic block model is one type of stochastic block model in which objects can belong to more than one community. More specifically, each object is associated with a vector whose entries represent the probabilities that the object belongs to the communities.

### SUMMARY

In a first aspect, a predictive model that accounts for both content (such as words, papers, materials, properties and ontologies) and context (such as journals, conferences, authors, etc) is more predictive of novelty and scientific progress than a predictive model based on content alone. Scientific hypotheses may be generated by analyzing both scientific literature and publication meta-data. This strategy incorporates information on the evolving distribution of scientific expertise, balancing exploration and exploitation in experimental search that enables the prediction of novel hypotheses.

To demonstrate the power of accounting for human experts, transition probability and deepwalk metrics are used to build discovery predictors and evaluate their predictions against the ground-truth discoveries that occur in reality. Algorithms assess the similarity between each property and the materials available to scientists in the literature published prior to a given prediction year (e.g., 2001), then selects the 50 most similar as predicted discoveries. Quality of predictions are evaluated based on materials discovered and published after the prediction year.

In an exemplary embodiment, a predictive model as disclosed herein may evaluate the valuable electrochemical properties of thermoelectricity, ferroelectricity and photovoltaic capacity against a pool of 100K candidate compounds. Using a dataset of 1.5M scientific articles about inorganic materials, future discoveries as a function of research publicly available to contemporary scientists were predicted. Predictions accounting for the distribution of scientists (context) outperformed baselines for all properties and materials.

In a further exemplary embodiment, the repurposing of approximately 4K existing FDA-approved drugs to treat 100 important human diseases was modeled using a dataset of the MEDLINE database of biomedical research publications. To evaluate the historical accuracy of the model, ground-truth discoveries were based on drug-disease associations established by expert curators of the Comparative Toxicogenomics Database (CTD)), which chronicles the capacity of chemicals to influence human health. Predictions accounting for the distribution of biomedical experts in the unsupervised hypergraph embedding yields predictions with 43% higher precision than identical models accounting for article content alone.

The present embodiments include high-order stochastic block models that expand the mixed membership stochastic block model to higher dimensions. This is accomplished by representing data with a hypergraph, rather than a graph. In a hypergraph, more than two objects can be joined with a hyperedge, thereby allowing higher-order interactions between objects to be directly represented. Therefore, the present embodiments are not limited by pairwise linking of objects in graphs, and are therefore capable of discovering higher-order structure that is more difficult to detect, if at all, with prior-art techniques.

The present embodiments cover both training of high-order stochastic block models, as well as their subsequent use (i.e., after training) to generate predictions that are more accurate than those generated by prior-art block models. The present embodiments may be used for any application that uses stochastic block models, including the study of transportation networks, predicting patterns of scientific and technological discovery, clustering of web pages, predicting functionality of proteins, and social network analysis.

### BRIEF DESCRIPTION OF THE DRAWINGS

FIG. 1 illustrates a high-order stochastic block model constructed from a sequence of hypergraph generators, in embodiments.

FIG. 2 illustrates a first-order hidden Markov model (HMM) used to train the block model of FIG. 1, in an embodiment.

FIG. 3 is a block diagram of a method for training the HMI of FIG. 2, in embodiments.

FIG. 4 is a block diagram of a method for generating a next hypergraph in embodiments.

FIG. 5 shows a system for high-order stochastic block modeling, in embodiments.

FIG. 6 illustrates a method of modeling predicted hypotheses using a hypergraph model, in embodiments.

FIG. 7 is a schematic diagram of an α-modified random walk for use in the method of FIG. 6, in embodiments.

FIG. 8 illustrates visualizations and the performance of a hypergraph-based algorithm in identifying discovering authors, in embodiments.

FIG. 9 illustrates charts showing Precision-Recall Area Under the Curve (PR-AUC) for predicting experts who will discover particular materials possessing specific properties, in embodiments.

FIG. 10 is a schematic diagram illustrating possible scenarios where a hidden underlying relationship between material M and property P may exist, in embodiments.

FIGS. 11A-11B illustrate a method of modeling disruptive hypotheses, in embodiments.

FIG. 12 illustrates discoveries made by scientists versus discoveries made to the disruptive AI model of FIGS. 11A-11B, in embodiments.

FIG. 13 is a flowchart of an example process for high-order modeling of predictive hypotheses.

FIG. 14 shows a system for high-order modeling of predictive hypotheses, in embodiments.

### DETAILED DESCRIPTION OF THE EMBODIMENTS

Breakthrough discoveries and inventions often involve unexpected observations or findings, stimulating scientists to forge new claims that make the surprising unsurprising and pushing science forward. Drawing on data from tens of millions of research papers and patents across the life sciences, physical sciences and patented inventions, it can be seen that surprising successes systematically emerge across, rather than within researchers; most commonly when those in one field publish problem-solving results to audiences in a distant other. Models may be constructed that predict next year's combinations of contents including problems, methods, and natural entities, and also contexts such as journals, subfields, and conferences. The models measure the unexpectedness of new combinations with their improbabilities, and also identify the sources, contents and contexts—of the novel findings. Embodiments disclosed herein empirically demonstrate and quantify the role of surprise in advancing science and technology, and provide tools to evaluate and potentially generate new hypotheses and ideas. Most of those surprising successes occurred not necessarily through interdisciplinary careers or multi-disciplinary teams, but from scientists in one domain solving problems in a distant other. surprising successes systematically emerge across, rather than within researchers; most commonly when those in one field surprisingly publish problem-solving results to audiences in a distant other.

In order to identify the sources of scientific and technological surprise, it is helpful to build models based on past disclosures followed by recognized breakthroughs. Discovery and invention may be modeled as combinatorial processes linking previous ideas, phenomena and technologies. In embodiments, combinations of scientific contents and contexts are separated in order to refine expectations about normal scientific and technological developments in the future. A new scientific or technological configuration of contents—phenomena, concepts, and methods—may surprise because it has never succeeded before, despite having been considered and attempted. A new configuration of contents that cuts across divergent contexts—journals and conferences—may surprise because it has never been imagined. The separate consideration of contents and contexts allows a contrast of scientific discovery with technological search: Fields and their boundaries are clear and ever-present for scientists at all phases of scientific production, publishing and promotion, but largely invisible for technological invention and its certification in legally protected patents.

In embodiments, a method of predicting novel combinations of science and technology uses a complex hypergraph drawn from an embedding of contents and contexts using mixed-membership, high-dimensional stochastic block models, where each discovery or invention can be rendered as a complete set of scientific contents and contexts. Adding this higher-order structure both improves prediction of new articles and patents as well as those that achieve outsized success.

In embodiments, a method of predicting novel combinations is applied to a corpus of scientific knowledge and technological advance. For purposes of illustration, the following discussion will refer to three corpora: 19,916,562 biomedical articles published between 1865-2009 from the MEDLINE database; 541,448 articles published between 1893-2013 in the physical sciences from journals published by the American Physical Society (APS), and 6,488,262 patents granted between 1979-2017 from the US Patent database. The building blocks of content for those articles and patents are identified using community-curated ontologies—Medical Subject Heading (MeSH) terms for MEDLINE, Physics and Astronomy Classification Scheme (PACS) codes for APS, and United States Patent Classification (USPC) codes for patents (see Methods for details). As discussed in more detail below, a hypergraph will be built for each dataset in each year where each node represents a code from the ontologies and each hyperedge corresponds to a paper or patent that inscribes a combination of those nodes, and compute node embeddings in those hypergraphs.

Corresponding hypergraphs may be built from context where nodes represent journals, conferences, and major technological areas (for patents) that scientists and inventors draw upon in generating new work. Each hyperedge corresponds to a paper or patent that inscribes a combination of context nodes cited in its references. To predict new combinations, the method uses a generative model that extends the mixed-membership stochastic block model into high-dimensions, probabilistically characterizing common patterns of complete combinations. The likelihood that contents or contexts become combined is modeled as a function of their (1) complementarily in a latent embedding space and (2) cognitive availability to scientists through prior usage frequency. Specifically, each node i is associated with an embedding (i.e., a latent vector) θᵢ that embeds the node in a latent space constructed to optimize the likelihood of the observed papers and patents. Each entry θ_{id} of the latent vector denotes the probability that node i belongs to a latent dimension d. The complementarity between contents or contexts in a combination h is modeled as the probability that those nodes load on the same dimensions, Σ_{d}Π_{i∈h}θ_{id}.

In embodiments, the model accounts for the cognitive availability of each content and context as most empirical networks display great heterogeneity in node connectivity, with a few popular contents and contexts intensively drawn upon by many papers and patents. Accordingly, each node i is associated with a latent scalar rᵢ to account for its cognitive availability or the exposure scientists have had to it, measuring its overall connectivity in the network. The propensity (λₕ) of combination h, i.e., the expectation of its appearance in actual papers and patents, is then modeled as the product of the complementarity between the nodes in h and their availability: λₕ=Σ_{d}Π_{i∈h}θ_{id}×Π_{i∈}rᵢ. Then the number of publications or patents that realize combination h is modeled as a Poisson random variable with λₕ as its mean. Finally, the likelihood of a hypergraph G is the product of the likelihood of observing every possible combination.

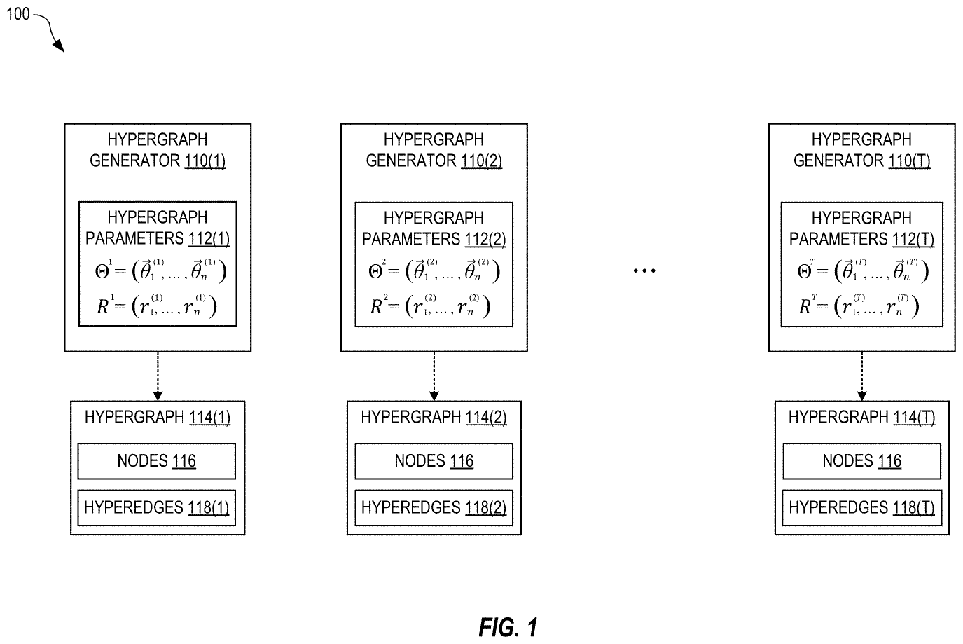

FIG. 1 illustrates a high-order stochastic block model 100 constructed from a sequence of T hypergraph generators 110(1), 110(2), . . . , 110(T), in embodiments. Each hypergraph generator 110(i) stores a corresponding set of hypergraph parameters 112(i), where i is an index from 1 to T. Each hypergraph generator 110(i) can stochastically generate, based on its set of hypergraph parameters 112(i), a plurality of hyperedges 118(i) to create a corresponding hypergraph 114(i) having a plurality of n nodes 116. Thus, the hypergraphs 114(1), . . . , 114(T) form a sequence corresponding to the sequence of hypergraph generators 110. Each hyperedge joins, or connects, two or more of the nodes 116. It is assumed herein that all of the hypergraphs 114 have the same nodes 116.

The block model 100 is a generative model that can be used to construct a next hypergraph 114(T+1), of the sequence of hypergraphs, that serves as a prediction. As described in more detail below, a plurality of T training hypergraphs can be used to train the block model 100. After training, the next hypergraph 114(T+1) can be constructed from the final hypergraph parameters 112(T). For example, the index i=1, . . . , T may represent different periods of time (e.g., year or month) for which training data exists, in which the next hypergraph 114(T+1) is a prediction for a future time. However, the index i may represent a different variable (i.e., other than time) from which a sequence can be formed.

In FIG. 1, each set of hypergraph parameters 112(i) is indicated as an array of vectors Θⁱ=(\vec{θ}₁⁽ⁱ⁾, . . . , \vec{θ}ₙ⁽ⁱ⁾), where each vector \vec{θ}ⱼ⁽ⁱ⁾ represents a position of the node j in an N-dimensional latent vector space, and j=1, n is an index over the nodes 116. Due to the expected sparsity of the hypergraphs 114, N can be much less than n, which advantageously speeds up training of the block model 100 by reducing the necessary computational resources. For example, n can be as large as one million, or more, while N may be 32. Generating n-dimensional hypergraphs 114 using N-dimensional parameters may be viewed as an example of an autoencoder.

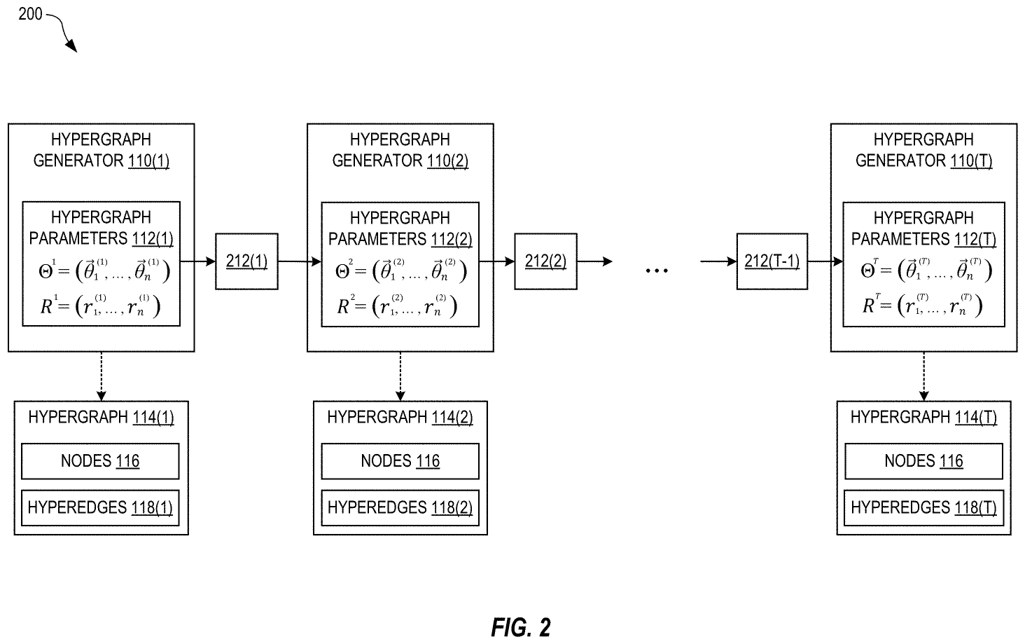

FIG. 2 illustrates a first-order hidden Markov model (HMM) 200 used to train the block model 100, in an embodiment. With the HMM 200, the set of hypergraph parameters 112(i) depends, at least in part, on previous sets of hypergraph parameters 112(1), 112(2), . . . , 112(i−1) such that the sequence of sets of hypergraph parameters 112 has memory. The HMM is first-order in the sense that the set of hypergraph parameters 112(i) only depends explicitly on the immediately previous set of hypergraph parameters 112(i−1) in the sequence, and therefore the hypergraph parameters 112(i) depend implicitly on the hypergraph parameters 112(1), 112(2), . . . , 112(i−2). Those skilled in the art will recognize how to modify the HMM 200 for other orders (e.g., second-order) and types of sequences with memory.

Each hypergraph generator 110(i) serves as a hidden state of the HMI 200. Each pair of consecutive hypergraph generators 110(i) and 110(i+1) is linked by a state-transition probability 212(i) that, as described in more detail below, introduces memory between the hypergraph parameters 112(i+1) and 112(i). The hypergraphs 114 serve as (unhidden) observations of the HMM 200. However, no hypergraph 114 need be generated during training.

The goal of the training method 300 is to find optimal hypergraph parameters 112, i.e., hypergraph parameters 112 that maximize (or minimize) a cost function. Specifically, the set of hypergraph parameters 112(i) is optimized when the probability that the hypergraph generator 110(i) generates, based on the hypergraph parameters 112(i), the training hypergraph Gⁱ is maximized. Mathematically, P(Gⁱ|Θⁱ) represents the probability that the hypergraph generator 110(i) will generate the training hypergraph Gⁱ based on the hypergraph parameters Θⁱ. Combining this probability for each hypergraph generator 110 yields a global probability

$$P ( {G}^{1} , … , {G}^{T} \vert {Θ}^{1} , … , {Θ}^{T} ) = P ( {G}^{1} \vert {Θ}^{1} ) {\prod }_{i = 2}^{T} P ( {Θ}^{i} \vert {Θ}^{i - 1} ) P ( {G}^{i} \vert {Θ}^{i} ) \qquad ( 1 )$$

that serves as the cost function for training. In Eqn. 1, P(Θⁱ|Θⁱ⁻¹) is the transition probability 212(i−1) of FIG. 2.

In some embodiments, the transition probability P(Θⁱ|Θⁱ⁻¹) is randomly selected from a multi-dimensional Gaussian distribution centered at Θⁱ⁻¹. To appreciate the effect of the transition probabilities P(Θⁱ|Θⁱ⁻¹), consider Eqn. 1 when these terms are absent. In this case, the global probability of Eqn. 1 can be maximized by maximizing each of the single-hypergraph probabilities P(Gⁱ|Θⁱ) independently. In this case, the optimal hypergraph parameters Θⁱ are determined solely by the training hypergraph Gⁱ, and it is possible for a large jump to occur between one set of optimized hypergraph parameters Θⁱ⁻¹ and the sequentially next set of optimized hypergraph parameters Θⁱ.

The transition probabilities P(Θⁱ|Θⁱ⁻¹), when included in Eqn. 1, help to keep the hypergraph parameters Θⁱ close to Θⁱ⁻¹ by making it mathematically “costly” for a large jump to occur. In this case, the optimal hypergraph parameters Θⁱ are determined by both the training hypergraph Gⁱ and the previous parameters Θⁱ⁻¹. This dependence of Θⁱ on Θⁱ⁻¹ is the source of first-order memory in the HMM 200. The width of the Gaussian distribution (i.e., in each of the N dimensions) determines, to some degree, a “memory strength” that quantities how strongly Θⁱ is forced to remain close to Θⁱ⁻¹ (to maximize Eqn. 1). The inventors have discovered that performance of the present embodiments is similar over a width range of Gaussian widths, and therefore the exact values of these Gaussian widths are not critical. The transition probability P(Θⁱ|Θⁱ⁻¹) may be randomly selected from another type of probability distribution without departing from the scope hereof.

In some embodiments, each single-hypergraph probability P(Gⁱ|Θⁱ) can be determined from the equation

$$P ( {G}^{i} \vert {Θ}^{i} ) = {Π}_{h ∈ H} P ( {x}_{h} \vert {Θ}^{i} ) , \qquad ( 2 )$$

wherein h is an index over a set H of combinations of the n nodes, and P(xₕ|Θⁱ) is a node-combination probability, based on the generator parameters Θⁱ, of observing xₕ hyperedges in the training hypergraph Gⁱ for the combination h. More specifically, the node-combination probability P(xₕ|Θⁱ) is the probability that the hypergraph generator 110(i) will generate a hypergraph 112(i), based on the hypergraph parameters Θⁱ, having xₕ hyperedges joining the nodes of the combination h.

In some embodiments, each node-combination probability P(xₕ|Θⁱ) is assumed to come from a Poisson distribution with mean

$${λ}_{h} = {\sum }_{d = 1}^{N} {Π}_{j ∈ h} {θ}_{j , d}^{( i )} , \qquad ( 3 )$$

where j is an index over each node of the combination h, and d is an index over the N dimensions of the latent vector space. The hypergraph parameters are expressed in terms of their vector components, i.e., \vec{θ}ⱼ⁽ⁱ⁾=(θ_{j,1}⁽ⁱ⁾, θ_{j,2}⁽ⁱ⁾, . . . , θ_{j,N}⁽ⁱ⁾), where each vector component θ_{j,d}⁽ⁱ⁾ represents a probability that the node j belongs to the d^{th} dimension of the latent vector space. The value λₕ may also be referred to herein as a “propensity” of the combination h, i.e., the expectation of the appearance of the combination h in a hypergraph. In the case of Eqn. 3, the propensity is equal to the complementarity between the nodes of the combination h, i.e., the probability that all of the nodes of the combination h “load on” the same dimensions of the latent vector space.

In some embodiments, each set of hypergraph parameters 112(i) also includes parameters R¹=(r₁⁽ⁱ⁾, r₂⁽ⁱ⁾, . . . rₙ⁽ⁱ⁾) in addition to the parameters Θⁱ. As described in more detail in Appendix A, each of the n nodes 116 has one corresponding scalar value of r accounting for the “cognitive availability” of that node. Each value of rⱼ⁽ⁱ⁾ thereby quantifies how well-connected the node j is to other nodes in a training hypergraph Gⁱ. The parameters Rⁱ are trained simultaneously with the parameters Θⁱ. In these embodiments, the global probability of Eqn. 1 becomes

$$P ( {G}^{1} , … , {G}^{T} \vert {Θ}^{1} , … , {Θ}^{T} , {R}^{1} , … , {R}^{T} ) = P ( {G}^{1} \vert {Θ}^{1} , {R}^{1} ) {\prod }_{i = 2}^{T} P ( {Θ}^{i} , {R}^{i} \vert {Θ}^{i - 1} , {R}^{i - 1} ) P ( {G}^{i} \vert {Θ}^{i} , {R}^{i} ) , \qquad ( 4 )$$

each single-hypergraph probability P(Gⁱ|Θⁱ) of Eqn. 2 becomes

$$P ( {G}^{i} \vert {Θ}^{i} , {R}^{i} ) = {Π}_{h ∈ H} P ( {x}_{h} \vert {Θ}^{i} , {R}^{i} ) , \qquad ( 5 )$$

and the mean of Eqn. 3 becomes

$${λ}_{h} = {\sum }_{d = 1}^{N} {Π}_{j ∈ h} {θ}_{j , d}^{( i )} \times {Π}_{j ∈ h} {r}_{j}^{( i )} . \qquad ( 6 )$$

In Eqn. 6, the term Π_{j∈h}rⱼ⁽ⁱ⁾ is also referred to herein as the availability. Thus, in the case of Eqn. 6, the propensity λₕ is equal to the product of the complementary and the availability.

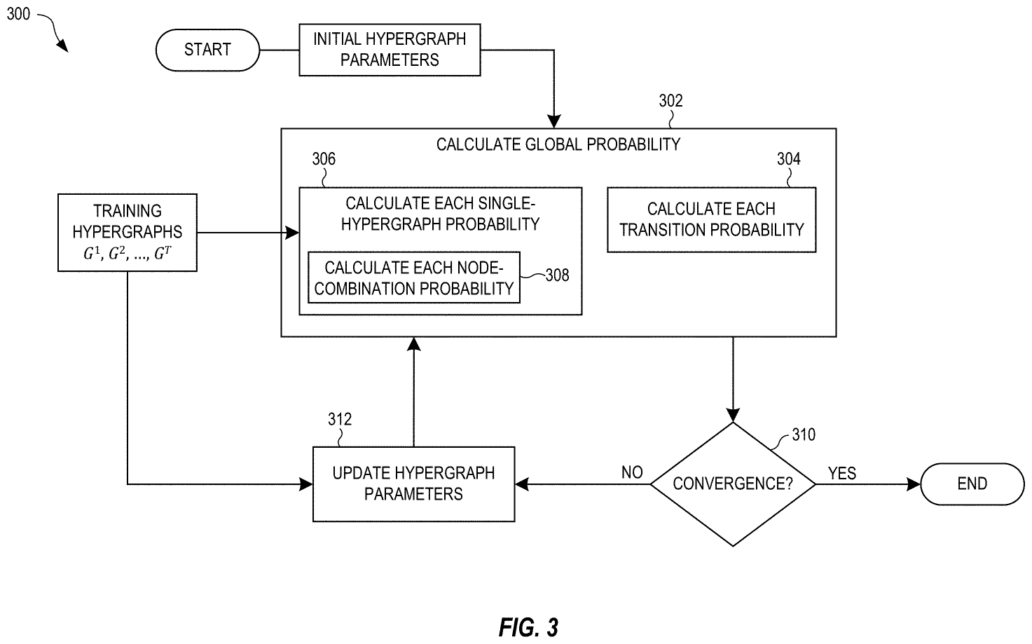

FIG. 3 is a block diagram of a method 300 for training the HMI 200, in embodiments. At the start of the method 300, initial values for all of the hypergraph parameters Θ¹, . . . , Θ^{T} are passed to a block 302, where a global probability is calculated based on the initial values. In embodiments where the additional parameters R¹, R², . . . , R^{T} are included, initial values for these additional values are also passed to the block 302. The block 302 may also use the training hypergraphs G¹, G², . . . , G^{T} to calculate the global probability, as shown in FIG. 3. In one example of the block 302, the global probability P is calculated using either Eqn. 1 or Eqn. 4.

For embodiments where the global probability can be expressed in terms of single-hypergraph probabilities, the block 302 may include a block 306 in which each single-hypergraph probability is calculated. In one example of the block 306, each single-hypergraph probability P(Gⁱ|Θⁱ) is calculated using Eqn. 2 (or Eqn. 5, when the additional parameters R¹, R², . . . , R^{T} are included). For embodiments where each single-graph probability can be expressed in terms of node-combination probabilities, the block 306 may include a block 308 in which each node-combination probability is calculated. In one example of the block 308, the node-combination probability of each combination h of nodes is calculated from a Poisson distribution having a mean given by Eqn. 3 (or Eqn. 6, when the additional parameters R¹, R², . . . , R^{T} are included). The block may also include a block 304 in which each transition probability is calculated.

In a decision block 310, the most recent global probability outputted by the block 302 is compared to a previous global probability to determine if the global probability has converged. If so, then the method 300 ends. If not, the method 300 continues to a block 312 in which all the hypergraph parameters are Θ¹, . . . , Θ^{T} are updated. For example, the hypergraph parameters may be updated using stochastic gradient descent (or ascent, depending on how the cost function is defined). The updated hypergraph parameters are then passed to the block 302, where a new value of the global probability is calculated. The blocks 302, 310, and 312 therefore form an iterative loop that continues until the global probability has converged. When the method 300 ends, the hypergraph parameters Θ¹, . . . , Θ^{T} will have their optimized values.

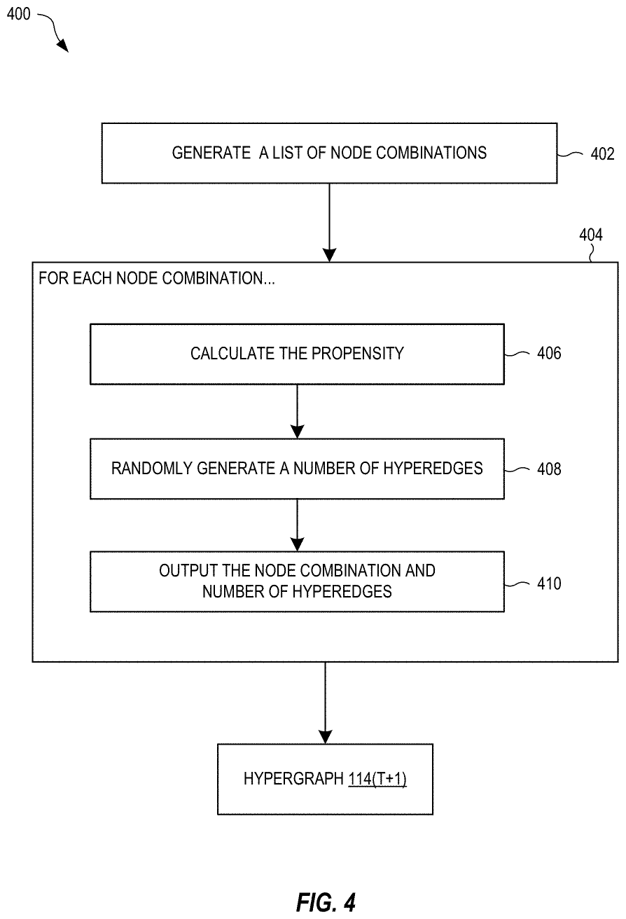

FIG. 4 is a block diagram of a method 400 for generating a next hypergraph 114(T+1) based on the hypergraph parameters Θ^{T}, in embodiments. The method 400 may be performed after training, i.e., when the hypergraph parameters Θ^{T} are optimal. In the block 402, a list of node combinations is generated. Each combination is one non-empty subset of the n nodes 116. The list may include combinations having any number of nodes between 1 and n. In some embodiments, the combinations have at most a maximum number of nodes less than n. For example, the maximum number may be set equal to the greatest number of nodes observed in any hyperedge in any of the training hypergraphs. In this case, the next hypergraph 114(T+1) will not contain any hyperedge having a greater number of nodes than what has been observed.

The method 400 also contains a block 404 that iterates over blocks 406, 408, and 410 for each node combination h in the list generated by the block 402. In the block 406, the propensity λₕ is calculated for the node combination h based on the hypergraph parameters Θ^{T} (and parameters R^{T}, when included). In the block 408, a number of hyperedges joining the nodes of the combination h is randomly generated based on the propensity λₕ. For example, the number of hyperedges may be randomly generated from a Poisson distribution having the propensity λₕ as its mean. In the block 410, the combination h and number of hyperedges are outputted. The hypergraph 114(T+1) is fully defined by the number of hyperedges for every combination h of the nodes 116.

The method 400 can also be used for generating the hypergraph 114(T) based on the hypergraph parameters Θ^{T}, and therefore shows one example of how the hypergraph generator 110(T) can generate the hypergraph 114(T). Therefore, the method 400 assumes that the hypergraph parameters Θ^{T+1} if they were to exist, would be minimally different, on average, from the hypergraph parameters Θ^{T}. That is, the hypergraph parameters Θ^{T+1} are approximately equal to the hypergraph parameters Θ^{T}.

As an alternative to generating the next hypergraph 114(T+1) as a prediction, the novelty of one or more combinations of nodes can be predicted. The novelty of a combination h in the next hypergraph 114(T+1) is defined by

$$s ( h ) = - log {\sum }_{d = 1}^{N} {Π}_{j ∈ h} {θ}_{j , d}^{( T + 1 )} \approx = - log {\sum }_{d = 1}^{N} {Π}_{j ∈ h} {θ}_{j , d}^{( T )} , \qquad ( 7 )$$

where the hypergraph parameters Θ^{T+1} are again approximated by the hypergraph parameters Θ^{T}. The novelty s(h) quantifies how surprising it would be to observe a hyperedge joining the nodes of the combination h. Although the novelty s(h) can be calculated directly from the next hypergraph 114(T+1), the novelty s(h) can be more quickly calculated by using only those hypergraph parameters for the nodes in the combination h. Thus, it is more efficient to obtain the novelty s(h) directly from Eqn. 7, as opposed to generating the next hypergraph 114(T+1).

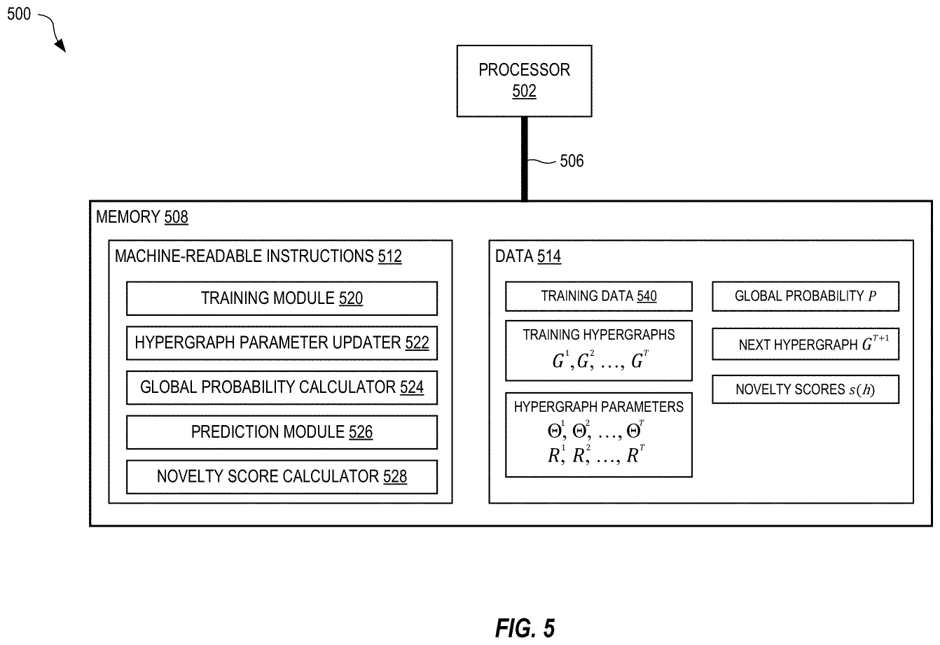

FIG. 5 shows a system 500 for high-order stochastic block modeling, in embodiments. The system 500 is a computing system in which a memory 508 is communicably coupled to a processor 502 over a bus 506. The processor 502 may be any type of circuit or chip capable of performing logic, control, and input/output operations. For example, the processor 502 may include one or more of a microprocessor with one or more central processing unit (CPU) cores, a graphics processing unit (GPU), a digital signal processor (DSP), a field-programmable gate array (FPGA), a system-on-chip (SoC), and a microcontroller unit (MCU). The processor 502 may also include a memory controller, bus controller, and other components that manage data flow between the processor 502, memory 508, and other devices connected to the bus 506.

The memory 508 stores machine-readable instructions 512 that, when executed by the processor 502 control the system 500 to implement the functionality and methods described above. The memory 508 also stores data 514 used by the processor 502 when executing the machine-readable instructions 512. In the example of FIG. 5, the machine-readable instructions 512 include a training module 520 that generates training hypergraphs G¹, G², . . . , G^{T} from training data 540, and trains the sequence of hypergraph generators to optimize hypergraph parameters Θ¹, Θ², . . . , Θ^{T}, R¹, R², . . . , R^{T} (e.g., see the method 300 of FIG. 3). The training module 520 may call a hypergraph parameter updater 522 that updates the hypergraph parameters during training (e.g., see the block 312 in FIG. 3). The training module 520 may also call a global probability calculator 524 that, based on the hypergraph parameters and training hypergraphs, calculates the global probability P (e.g., see the block 302 in FIG. 3). The machine-readable instructions 512 also include a prediction module 526 that generates the next hypergraph G^{T+1} based on the hypergraph parameters Θ^{T} and R^{T} (e.g., see the method 400 of FIG. 4). The machine-readable instructions 512 also include a novelty score calculator 524 that calculates the novelty scores s(h) for one or more combination of nodes (e.g., see the nodes 116 in FIGS. 1 and 2) based on the hypergraph parameters Θ^{T} and R^{T}. The memory 508 may store additional machine-readable instructions 512 and data 514 than shown in FIG. 5, as needed to implement the functionality and methods described herein.

The hypergraphs generated via the embodiments of systems and methods discussed above, with regards to FIGS. 1-5, provide an ability to perceptually characterize immense amounts of data (e.g., the corpus of documents including, but not limited to, papers and patents). The new hypergraphs herein not only allow for identification of surprising combinations of content and context within text descriptions of documents of a corpus used to create the hypergraphs, but also identify the sources of those surprising combinations. This advantage is realized by consideration of not only content nodes, but also context nodes, based on the complex hypergraphs drawn from an embedding of the contents and contexts using mixed-membership, high-dimensional stochastic block models, where each target variable can be represented as a complete set of contents and contexts.

Predictive models for citations or citation success have been one of the most impactful areas in science studies. However, most of those models are ex post, using features such as publication venue or early citations which are only available after a paper is published; and cannot “predict” how novel or successful an idea or hypothesis will be before it is already received by the public. After a paper is published, its impact is influenced by many factors other than its novelty or quality. Take the journal of publication as an example. Even though publication in a journal is a highly accurate predictor for impact, one cannot simply decide to write a paper that will be published in Science, the New England Journal of Medicine, or Nature. Reviewers for these world-leading, highly competitive publications evaluate manuscripts on many dimensions of rigor, novelty and style, often in conflict within and across reviewers, leading to high unpredictability. Of course, once such a manuscript makes it in, presence on one of those platforms will not reflect, but rather determine the citation outcomes.

Of greater interest are ex ante models of a scientific idea's success—aspects known once the research is completed, but before it is even written up or published. The hypergraph model described herein is a conceptual advance regarding appropriate representation that is theoretically grounded. The model is based on a simple mental process. Scientists and inventors combine things together that are cognitively available to them. As they navigate the knowledge space of scientific concepts and technological components, they combine those that are (1) salient and (2) proximate. The hypergraph model derives novelty from first principles: a combination is novel when it violates the expectation of a typical scientist navigating the mental map of prior knowledge. In other words, the hypergraph model of new papers and patents is also generative, unlike prior discriminative models (e.g., a scoring algorithm that suggests which discoveries and inventions are most novel). This means it enables the composition of new papers and patents. This represents a conceptual, not merely a technical, advance for two reasons. First, strong predictions capture the space of reasonable expectations and produce not merely an indicator of existential surprise, but a direct measurement of rational surprise. Second and more importantly, generative versus discriminative models portend the transition from science to technologically relevant insights. With a generative model of new discoveries and inventions, high-value and high-throughput hypotheses can be generated that accelerate the natural advancement of science, but also identify areas unlikely to have been explored naturally, as a function of fields and boundaries, but nevertheless merit promising exploration.

While the hypergraph models disclosed herein have achieved good performance in predicting future combinations and their successes, they may be further extended by leveraging machine learning such as a neural network (NN) architecture. In embodiments, an NN architecture such as Transformer may be used, but any architecture which is capable of processing sequence-like data may be used.

In embodiments, only encoder part of the NN architecture is used since there is no need to predict sequences of nodes and therefore, the decoder part is not necessary. As a combination of nodes is not strictly a sequence of nodes (the order of nodes in the combination does not matter), there is no need position encoding. The hypergraph block model (Eq. 6) is added on top of the encoder as the final output layer. In sum, a full forward pass of the hyper-NN proceeds as follows:

1. For every combination h of nodes

2. Pass it through an embedding layer which converts every node i∈h into an embedding vector θᵢ

3. Pass the list of embeddings {θᵢ}_{i∈h} through the encoder which outputs a new embedding θ′ᵢ for each i∈h. This is the key step of the model as it uses a mechanism called self-attention to update the embeddings of the nodes.

4. Apply the hypergraph block model to the new embeddings y=Σ_{d}Π_{i∈h} θ′ᵢ and output y as the final score for the combination h.

The hyper-NN model takes in a combination of nodes and outputs a scalar. It can be trained to predict different things depending on the target of the final output. For purposes of illustration, training the hyper-NN model to perform two tasks is now described.

The first task is to predict future hyperedges which are combinations that turn into target variables (e.g., future papers, future granted patents, future successful companies, future successful pharmaceuticals, etc.). The target is thus the number of papers (or patents) that realize a given combination. (For combinations that do not turn into papers, the number will be 0.) In training, for every combination, the loss between the output y from the hyper-NN model and the number of papers y* about this combination is assessed as

y−y*log(y)+log(y*!)

which is equivalent to the Poisson likelihood as in the hypergraph block model. The loss is then propagated back through the hyper-NN model and the model weights are updated with gradient descent. As in the training of the hypergraph block model, it is impossible to go through all possible combinations, and a negative sampling approach is taken here which samples a certain number of non-hyperedge combinations for each batch of hyperedges in training. This whole process is very similar to the hypergraph block model disclosed herein in FIGS. 1-5, except that the embeddings are passed through a NN encoder first. Since the hypergraph model already achieves good performance in predicting future hyperedges, there is little room for improvement and the hyper-NN model obtains a AUC of about 0.98. However, as the embeddings go through the NN encoder, they lose their original interpretations. In other words, θ′ᵢ is not necessarily the probability that node i belongs to a latent dimension d, and it is impossible to disentangle complementarity from availability as defined in the hypergraph block model. One consequence is that the surprisal or novelty of a combination, −log Σ_{d} Π_{i∈h}θ′ᵢ is no longer well defined and it cannot predict outsized successes. This also suggests that our hypergraph block model, although (relatively) simple, captures the essence of novelty. Nonetheless, we can still use the hyper-Transformer model to predict hit papers directly which is our second extension.

The second extension is to predict hit papers directly. In this case, the target is whether or not a target (e.g., a paper, patent, company, pharmaceutical composition, etc.) is a hit target in that it will be “disruptive” or successful as identified by the future prediction. This is a binary classification problem where the input is a combination of nodes representing a paper and the target is either 1 (if the paper is a hit) or 0 (if the paper is not). The hyper-NN model may be trained on all papers with the standard cross-entropy loss. As an illustration, when this model was trained on all papers published up to 1980 and used to predict hit papers in 1981; it achieved a high accuracy of 0.24.

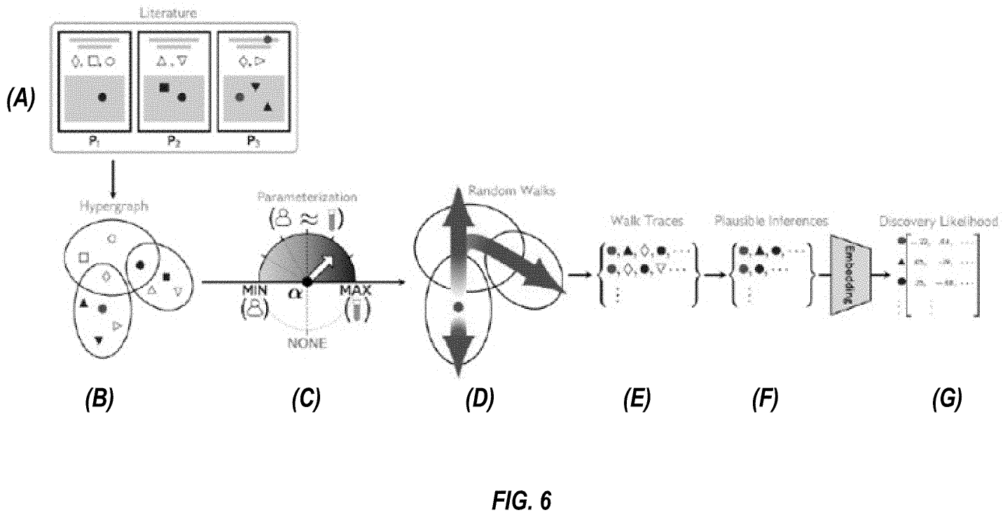

As explained above, the distribution of inferences cognitively available to scientists may be modeled by constructing a hypergraph over research publications. As discussed herein in FIGS. 1-5, a hypergraph is a generalized graph where an edge connects a set, rather than a pair, of nodes. In embodiments, a research hypergraph is mixed, containing nodes corresponding not only to content such as materials and properties mentioned in title or abstract, but also to context such as the researchers who investigate them. This is better illustrated in the method of modeling predicted hypotheses using a hypergraph model shown in FIG. 6. Step (A) shows three research papers P₁, P₂ and P₃. Uncolored (or un-filled) shapes represent authors and colored (or filled) shapes represent properties (red) or materials (blue) mentioned in the title and abstract of the papers. A hypergraph constructed based on the literature represented by papers P₁, P₂ and P₃ at (B).

Random walks over the hypergraph of step (B) suggest paths of inference cognitively available to active scientists, which can be used to identify mixtures of diverse expertise sufficient for discoveries. If a valuable material property (e.g., ferroelectricity—reversible electric polarization useful in sensors) is investigated by a scientist who, in prior research, worked with lead titanate (PbTiO₃, a ferroelectric material), that scientist is more likely to consider whether lead titanate is ferroelectric than a scientist without the research experience. If that scientist later coauthors with another who has previously worked with sodium nitrite (NaNO₂, another ferroelectric material), that scientist is more likely to consider that sodium nitrite may have the property through conversation than a scientist without the personal connection. The density of random walks over this research hypergraph will be proportional to the density of cognitively plausible and conversationally attainable inferences. If two literatures share no scientists, a random walk over our hypergraph will rarely bridge them, just as a scientist will rarely consider connecting a property valued only in one with a material understood only in another.

In embodiments, random walks as shown in step (D) induce meaningful proximities between nodes in the mixed hypergraph. The proximity of a material to a scientist measures the likelihood that he/she is or will become familiar with that concept through research experience, related reading, or social interaction. The proximity of materials to one another suggests that they may be substitutes or complements within the same experiment. The proximity of a material to a property suggests the likelihood that the material may possess the property, but also that a scientist will discover and publish it. In this way, hypergraph-induced proximities incorporate physical and material properties latent within literature, but also the complementary distribution of scientists, enabling anticipation of likely inferences and prediction of upcoming discoveries.

In embodiments, a hypergraph model:

(i) initiates a random walk over the research hypergraph with a target property (e.g., ferroelectricity),

(ii) randomly selects an article (hyperedge) with that property,

(iii) randomly selects a material or author from that article, then

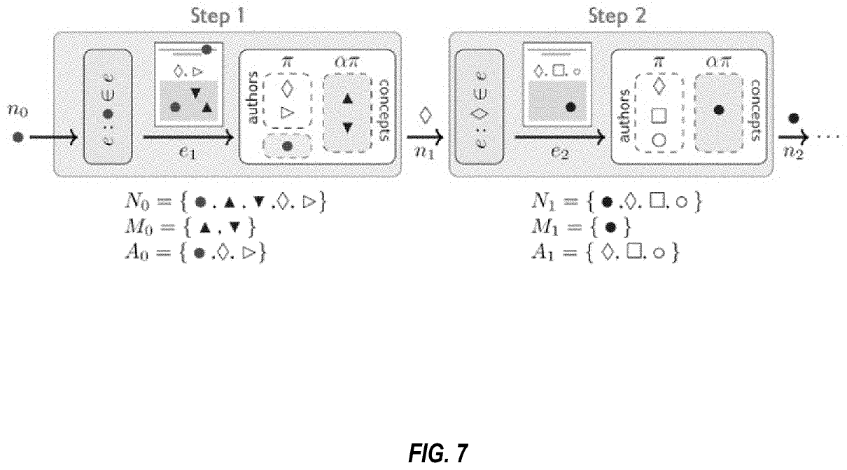

(iv) randomly selects another article with that material or author, etc., then repeats steps (i)-(iv). For some collections of papers, the author nodes in a hypergraph severely outnumber the materials. To compensate for this imbalance, a non-uniform sampling distribution parameterized by α, which determines the fraction of material to author nodes in the resulting sequences as shown in step (C). Further details are discussed in connection with FIG. 7 below.

Random walks induce similarity metrics that capture the relevance of nodes to one another. The first metric draws upon the local hypergraph structure to estimate the transition probability that a random walker travels from one node to another within a fixed number of steps. The second metric is based on a popular, unsupervised neural network-based embedding algorithm, (e.g., DeepWalk) over the generated random walks. When applied to the hypergraph, every random walk sequence (step (E)) is considered a “sentence” linking materials, experts and functional properties (e.g., store energy; cure breast cancer, vaccinate against COVID-19). Because inferred discoveries involve relevant materials, the DeepWalk embedding model is trained after excluding authors from our random walk sequences (step (F)). The resulting embedding maps every node to a numerical vector (step (G)), with the dot-product between any pair reflecting the human-inferable relatedness of corresponding nodes. A comparable embedding space may be created using deeper graph convolutional neural networks.

### Random Walks and Relevance Metrics

In practice, co-authorships that occurred long before the time of prediction will neither be cognitively available nor perceived as of continuing relevance. Therefore, prediction experiments may be restricted to use literature produced in the 5 years prior to the year of prediction. For each property of interest, 250,000 non-lazy, truncated random walks with and without α-modified sampling distribution sequences were taken. All walks start from the property node and end either after 20 steps or after reaching a dead-end node with no further connections. The α-modified sampling algorithm is implemented as a mixture of two uniform distributions over authors and materials such that the mixing coefficient assigned to the latter is a times the coefficient of the former. Hence, a is the probability ratio of selecting material to author nodes (see FIG. 7 below for more details). Three values for this parameter in were used in experiments:

α=1, which implies an equal probability of sampling authors and materials, α→∞ which only samples materials and α=0 which only samples authors. The author-only mode yielded lower performance in comparison to the other two.

### Multistep Transition Probabilities

Once the random walk sequences are sampled, the two hypergraph-induced similarities may be computed. Multi-step transition probabilities are directly computed from transition matrices using Bayesian rules and Markovian assumptions. The first similarity metric used based on our random walk settings (discussed in more detail below) was based on multistep transitions from the property node (denoted by P) to a target material (denoted by M). Two- and three-step transitions were considered with intermediate nodes conditioned to belong to the set of authoring experts (denoted by A). In each case, the starting node no is set to the property node and the probability that a random walker reaches Min two or three steps is computed, i.e., n₂=M or n₃=M, respectively. Therefore, the probability of a two-step transition through an intermediate author node is computed:

$$\begin{matrix}Pr ( {n}_{2} = M , {n}_{1} ∈ A \vert {n}_{0} = P ) = {\sum }_{α ∈ A} Pr ( {n}_{2} = M , {n}_{1} ∈ A \vert {n}_{0} = P ) \\ = {\sum }_{α ∈ A} Pr ( {n}_{1} = α \vert {n}_{0} = P ) , Pr ( {n}_{2} = M \vert {n}_{1} = α )\end{matrix}$$

where the second line draws on the independence assumptions implied by the Markovian process of random walks. Similar formulation could be derived for three-step transition. The individual transition probabilities in the second line are readily available based on our definition of a hypergraph random walk. For example, for a classic random walk with uniform sampling distribution:

$$Pr ( {n}_{1} = α \vert {n}_{0} = P ) = \frac{1}{d ( P )} {\sum }_{e \text{:} \{ P , A \} ∈ A} \frac{1}{d ( e )}$$

where d(P) is the degree of node P, i.e., the number of hyperedges it belongs to, and d(e) is the size of hyperedge e, i.e., the number of distinct nodes inside it. The first multiplicand in the right-hand side of above equation accounts for selecting a hyperedge that includes P and the second computes the probability of selecting A from one of the common hyperedges (if any). The above computations can be compactly represented and efficiently implemented through matrix multiplication. Let P represent the transition probability matrix over all nodes such that Pᵢⱼ=Pr(n₁=j|n₀=i). Then, two- and three-step transitions between nodes P and M could be computed via P(P, [A]). P([A], M) and P(P, [A]). P([A], [A]). P([A], M), respectively, where P(P, [A]) defines selection of the row corresponding to node P and columns corresponding to authors in set A.

For DeepWalk representation, we train a skip-gram Word2Vec model with the embedding dimensionality set to 200 and the number of epochs reduced from 30 to 5. Size of vocabularies produced by DeepWalk sampling is much smaller than the number of distinct words in literature contents. As a result, they require less effort and lower training iterations to capture the underlying inter-node relationships. Note that DeepWalk embedding similarity is more global than the transition probability metric, provided that the length of our walks (−20) are longer than the number of transition steps (2 or 3). Moreover, it is more flexible as the walker's edge selection probability distribution can be easily modified to explore the network structure more deeply (7). Nevertheless, because the DeepWalk Word2Vec is trained using a window of only length 8, only authors and materials that might find each other through conversation, seminar or conference would be near one another in the resulting vector space.

In embodiments, prediction experiments were run after replacing the DeepWalk representation with a graph convolutional neural network. In an exemplary embodiment, the Graph Sample and Aggregate (GraphSAGE) model with 400 and 200 as the dimensionality of hidden and output layers with Rectified Linear Units (ReLU) may be used as the non-linear activation in the network. Convolutional models require feature vectors for all nodes but the hypergraph is inherently feature-less. Therefore, the word embeddings obtained by our Word2Vec baseline may be utilized as feature vectors for materials and property nodes. A graph auto-encoder was then built using the GraphSAGE architecture as the encoder and an inner-product decoder and its parameters were tuned by minimizing the unsupervised link-prediction loss function. The output of the encoder is taken as the embedded vectors and selected the top 50 discovery candidates by choosing entities with the highest cosine similarities to the property node. In order to evaluate the importance of the distribution of experts for our prediction power, this model was trained on the full hypergraph and also after withdrawing the author nodes. Running the convolutional model on energy-related materials and properties yielded 62%, 58% and 74% precisions on the full graph, and 48%, 50% and 58% on the author-less graph for thermoelectricity, ferroelectricity and photovoltaics, respectively. These results show a similar pattern to those obtained from DeepWalk although with somewhat smaller margin, likely due to the use of Word2Vec-based feature vectors, which limit the domain of exploration by the resulting embedding model to within proximity of the baseline.

### α-Modified Random Walk

FIG. 7 is a schematic diagram of an α-modified random walk for use in the method of FIGS. 6A-6G, in embodiments.

The number of author and material nodes in our hypergraphs are not balanced in any of the data sets: (94% vs. 6%) in the materials science data set and (>99.95\% vs. <0.05%) in the drug repurposing data set. Hence, classic random walk with uniform node sampling in each step will result in sequences where author nodes severely outnumber materials. This especially can be seen in drug-disease cases. In order to mitigate this issue, a non-uniform node sampling distribution is used that can be tuned through a positive parameter denoted by a. Depending on the value of a, the algorithm samples materials more or less frequently than the authors. This parameter is officially defined as the ratio of the probability of sampling a material (if any) in any given paper to the probability of sampling a non-material node (either author or property nodes). This algorithm is implemented by a mixture of set-wise uniform sampling distributions. As a first step, denote the set of all nodes existing in the paper (hyperedge) of the i-th random walk step as Nᵢ. This set can be partitioned into material and non-material nodes denoted by Mᵢ and Aᵢ, respectively. While the standard random walk samples the next node nᵢ₊₁˜U(Nᵢ) from a uniform distribution over the unpartitioned set of nodes, i.e., nᵢ, U(Nᵢ), the a-modified random walk selects the next node by sampling from the following distribution (assuming both sets Mᵢ and Aᵢ are non-empty):

$${n}_{i + 1} ∼ \frac{1}{α + 1} U ( {A}_{i} ) + \frac{α}{α + 1} U ( {M}_{i} )$$

This is illustrated in FIG. 7. In embodiments, FIG. 7 shows two steps of an α-modified random walk, however, additional steps may be included. Blank shapes represent author nodes, which are referred herein as “context nodes” and colored shapes represent materials (blue) and the property (red), which are referred herein as “content nodes”. Papers (hyperedges) are sampled uniformly, whereas nodes are selected such that the probability of sampling material node is a times the probability of sampling an author. In the first step, one paper is uniformly selected from the set of publications containing the property keyword in their title or abstract e₁. The set of nodes and its two partitions are shown as N₀, M₀ and A₀. In each random walk step, the selected hyperedge is shown over the arrow (e₁ or e₂) and the hypernodes that it contains are listed below the figure (N₀ or N₁), which are in turn partitioned into material (M₀ or M₁) and non-material (A₀ or A₁) subsets. The output of the considered step will be a random draw from these hypernodes (n₁∈N₀ or n₂∈N₁). Here, π denotes the probability of sampling non-material nodes, which is uniquely determined by α itself. With probability

$$π = \frac{1}{α + 1}$$

the walker picks out the next sample n₁ from A₀ and with probability

$$\frac{α}{α + 1}$$

the next sample will be from M₀. As α gets larger the probability of sampling materials, and therefore their frequency in the resulting random walk sequences, increases. In the limit as α→∞, the walker only samples materials unless the sampled paper does not contain any material nodes, in which case the sampling process is terminated.

### Expert-Sensitive Prediction

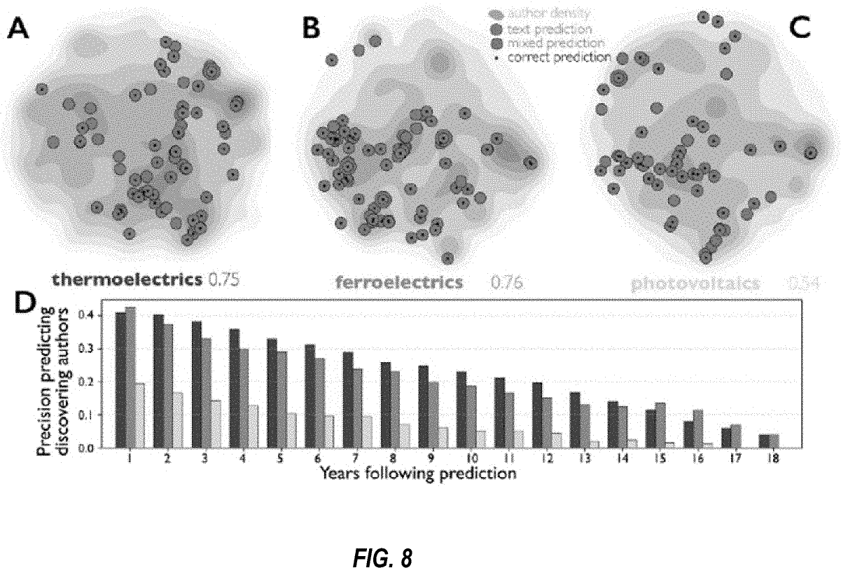

In embodiments, the predictive models disclosed herein use the distribution of discovering experts to successfully improve discovery prediction. To demonstrate this, consider the time required to make a discovery. Materials cognitively close to the community of researchers who study a given property receive greater attention and are likely to be investigated, discovered and published earlier than those further from the community. In other words, “time to discovery” should be inversely proportional to the size of the expert population aware of both property and material. The size of this population may be measured by defining expert density as the Jaccard index of two sets of experts: those who mentioned a property and those who mentioned a specific material in recent publications. For all three electrochemical properties mentioned earlier, correlations between discovery date and expert densities were negative, significant and substantial, confirming that materials considered by a larger crowd of property experts are discovered sooner. This may be seen based on embedding proximities: FIG. 8 illustrates how predictions cluster atop density peaks in a joint embedding space of experts and the materials they investigate. These expert-material proximities are able to predict discoverers most likely to publish discoveries based on their unique research backgrounds and relationships. Moreover, computing the probability of transition from properties to expert nodes through a single intermediate material across 17 prediction years (2001 to 2017), shows that 40% of the top 50 ranked potential authors became actual discoverers of thermoelectric and ferroelectric materials one year after prediction, and 20% of the top 50 discovered novel photovoltaics.

Two-dimensional projections of expert-sensitive material predictions made by DeepWalk (blue circles) and content-exclusive Word2Vec model (red circles) are shown for thermoelectricity at (A), ferroelectricity at (B) and photovoltaic capacity at (C). Circles with center dot indicate true positive predictions discovered and published in subsequent years and empty circles are false positives. Predictions are plotted atop the density of experts (topo map and contours estimated by Kernel Density Estimation) in a 2D tSNE-projected embedding space. Before applying tSNE dimensionality reduction, the original embedding was obtained by training a Word2Vec model over sampled random walks across the hypergraph of published science. Red circles are more uniformly distributed, but blue circles concentrate near peaks of expert density.

Precision rates for predicting discoverers of materials with electrochemical properties are shown in the graph (D). Predictive models are build based on two-step transitions between property and expert nodes with an intermediate material in the transition path. Bars show average precision of expert predictions for individual years. An expert can publish a discovery in multiple years. Total precision rates are also shown near each property ignoring the repetition of discovering experts.

FIG. shows charts illustrating Precision-Recall Area Under the Curve (PR-AUC) for predicting experts who will discover particular materials possessing specific properties of thermoelectrics at (A), ferroelectrics at (B) and photovoltaics at (C). Materials were selected to be True Positive discovery predictions of the DeepWalk-based predictor (a=1). The evaluation here compares scores assigned to candidate and actual discovering experts who ultimately discovered and published the property associated with True Positives. A DeepWalk-based scoring function was developed for this purpose. Expert candidates are considered those that sampled at least once in DeepWalk trajectories, produced over a five-year period hypergraph. For a fixed (discovered) material, scores were computed based on proximity of experts to both property and material. An expert is a good candidate discoverer if he/she is close (in cosine similarity) to both property and material nodes in the embedded space. Discovered associations whose discoverers were not present in sampled deepwalk trajectories were ignored. In order to summarize the two similarities and generate a single set of expert predictions, experts are ranked based on their proximity to the property (RP) and the material (RM) and combined the two rankings using average aggregation. This ranking was used as the final expert score in the PR-AUC computations. The log-PR-AUC of this algorithm was compared with a random selection of experts and also with a curve simulating an imaginary method whose log-PR-AUC is five times higher than the random baseline. Results reveal that predictions were significantly superior to random expert selection for all electrochemical properties.

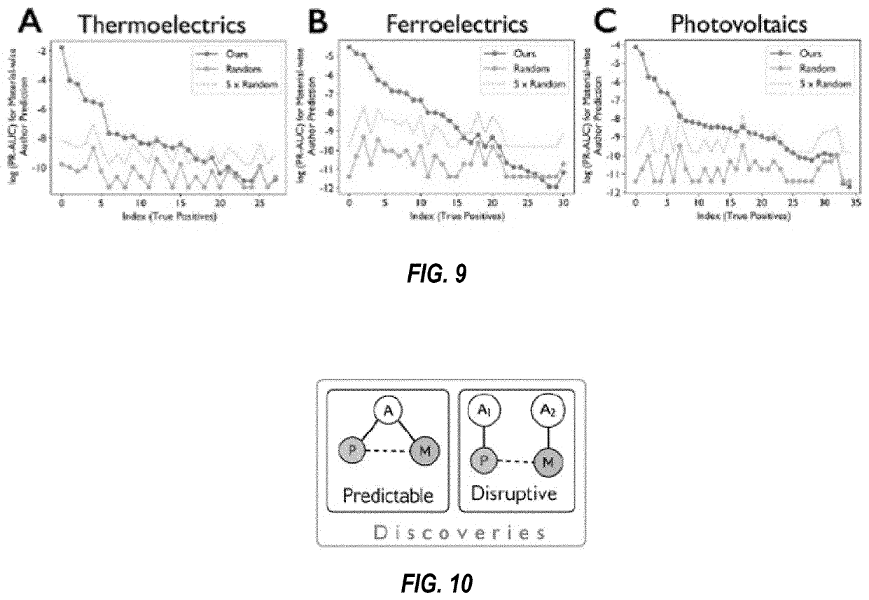

FIGS. 8-9 illustrate that analyzing content nodes and context nodes in the same hypergraph enables more accurate predictions. The ability to identify the content (e.g., the material that will be developed) in addition to the context (e.g., the candidate and actual discovering experts) not only increases accuracy, but the ability to analyze the hypergraph and eliminate those inferences that are not plausible (or analyze only those that are plausible), e.g., as shown in FIG. 6, steps (D)-(F) expedites computing time by eliminating potential connections within the hypergraph that are unlikely to impact a strong potential for discovery likelihood.

### Disruptive Predictions

As illustrated above, by identifying properties and materials cognitively available to human experts, the precision of predicting published material discoveries may be maximized. The algorithms disclosed herein owe their success to the fact that almost all published discoveries lie in close proximity to desired properties based on the literature hypergraph. This is because scientists research and publish about materials and properties discovered through previous experience and collaborations traced by it. By contrast, if the algorithms avoid the distribution of human experts, the methods disclosed herein can produce disruptive predictions designed to complement rather than mimic the scientific community. These predictions are cognitively unavailable to human experts based on the organization of scientific fields, prevailing scientific attention, and expert education, but nevertheless manifest heightened promise for possessing desired scientific properties. In embodiments, a framework that arbitrages disconnections in the hypergraph of science to identify disruptive discovery candidates more likely to possess desired properties than those that scientists investigate, which are unlikely to be discovered in the near future without machine recommendation. This principle is illustrated in FIG. 10.

FIG. 10 shows two possible scenarios when there exists a hidden underlying relationship between material M and property P waiting to be discovered. Uncolored circles represent non-overlapping populations of human experts and colored nodes indicate a material (colored in blue) or a property (colored in red). Solid lines between uncolored and colored nodes imply that the experts represented by the former studied or have experience with the material or property denoted by the latter. Dashed lines represent existing property-material links that have not been discovered yet. The P-M relation in the left scenario is likely to be discovered and published in the near future, but is likely to escape scientists' attention in the right scenario; it would disrupt the current course of science. Disruptive discoveries are identified within the hypergraph as those which are not 1^{st} or 2^{nd} order connections (e.g., directly connected or connected within 1 or more intermediate nodes), but their shortest path distance between the unconnected nodes is within a shortest path distance threshold. For example, in FIG. 10, content node P is within a shortest path distance threshold to content node M, but it is not coupled (directly or indirectly) because content node P is coupled to context node A1, and contend node M is coupled to context node A2.

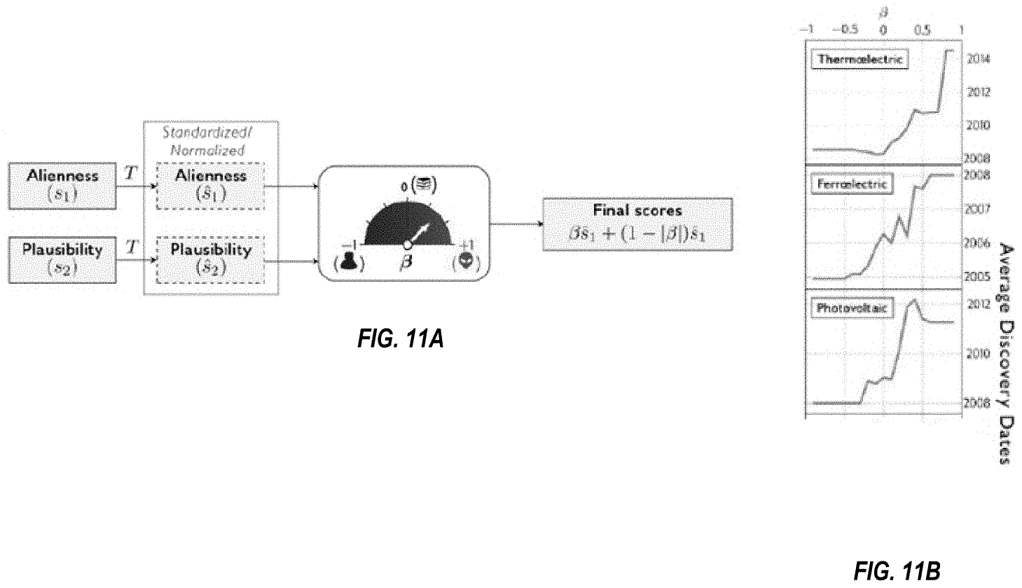

The framework combines two components: a human availability component that measures the degree to which candidate materials lie within or beyond the scope of human experts' research experiences and relationships, and a scientific plausibility component that amplifies predictions with promise as consistent with existing research and theory as shown in FIG. 11A. The two component scores are transformed into a unified scale and linearly combined with a simple mixing coefficient β. Setting β=0 implies an exclusive emphasis on scientific plausibility, blind to the distribution of experts. Decreasing β imitates human experts and increasing β avoids them. At extremes, β=−1 and 1 yield algorithms that generate predictions very familiar or very strange to experts, respectively, regardless of scientific merit. Non-zero positive βs balance exploitation of relevant materials with exploration of areas unlikely considered or examined by human experts. Materials with the highest scores are reported as the algorithm's prediction and evaluated as candidates for disruptive discovery. Human availability can be quantified with any graph distance metric varying with expert density (e.g., unsupervised neural embeddings, Markov transition probabilities, self-avoiding walks from Schramm-Loewner evolutions). In embodiments, shortest path distances between properties and materials are used, interlinked by authors, as above. Scientific plausibility may be quantified by unsupervised embeddings of published knowledge, theory-driven simulations of material properties, or both. In embodiments, unsupervised knowledge embeddings may be used for the algorithm, reserving theory-driven simulations to evaluate the value and human complementarity of the predictions. To evaluate thermoelectric promise, power factor (PF) represents an important component of the overall thermoelectric figure of merit, zT, calculated using density functional theory for candidate materials as a strong indication of thermoelectricity. To evaluate ferroelectricity, estimates of spontaneous polarization obtained through symmetry analysis and first-principle equations serve as a reliable metric for this property.

As shown in FIG. 11A, in a first step, the scores undergo the same transformation T, which is a combination of standardization and normalization, to be mapped into comparable scales. The transformed scores will then be linearly combined with parameterized by signed coefficient β varying from −1 (the most human-like prediction) to +1 (the most disruptive prediction) via 0 (neutral predictions, blind to human availability). For intermediate values of both plausibility and disruptiveness contribute to the final scores. When β>0, disruptiveness contributes positively and when β<0, its contribution is negative (encouraging human-like predictions).

The degree to which predictions complement human science may be evaluated in two ways, in embodiments. First, it is demonstrated that more disruptive predictions, if discovered by the scientific community, are discovered long after prediction—much later than the scientist-mimicking predictions described earlier, once the community has filled in knowledge gaps separating valued properties and unfamiliar materials (FIG. 11B). Second, it is demonstrated that more disruptive or human-avoiding predictions (those with a higher β) increase the scientific promise versus those made and published by the scientific community, as assessed using the precomputed theoretical scores described above. This is a very conservative estimate of scientific promise for disruptive predictions because it is based on widely accepted, scientist-crafted and theory-inspired or data-driven simulations. Nevertheless, even in this case, it can be seen that by avoiding the human crowd, higher βs can improve even this conventional measure of predicted promise. Specifically, the complementary performance of the disruptive predictor may be evaluated by verifying that the simulated quality of predictions corresponds with significantly higher values of β than for materials actually discovered. To assess this, we computed the difference between expected values of conditioned on when the prediction is scientifically promising and when it is found and published. A positive expectation gap measures the increase in β (or “disruptiveness”) that would maximize the prediction of materials with theoretically expected properties.

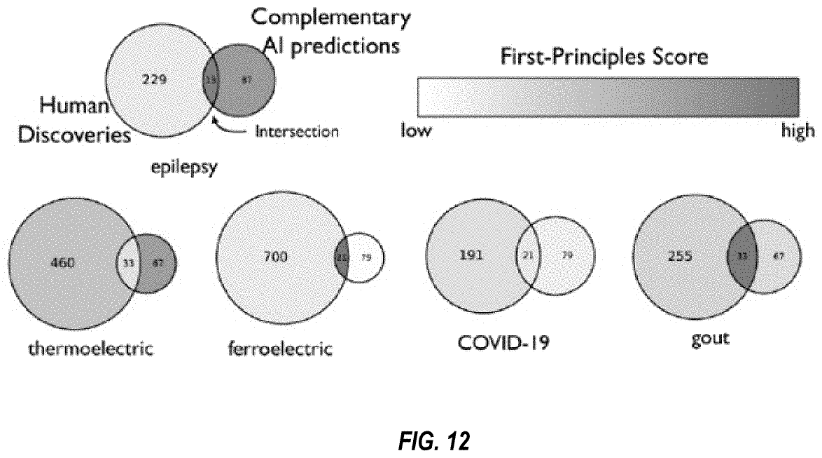

From here, the complementarity of a prediction may be directly calculated from the algorithm for the human scientific community in two ways. First, we compute the probability that it is plausible but not discoverable for any particular value of β. Second, there is the minimal overlap between published discoveries and disruptive predictions, which nevertheless retain or increase their theoretical merit as shown in FIG. 12, which illustrates Venn diagrams of discoveries made by scientists versus discoveries made to the disruptive AI model described herein.

### Scoring Candidate Materials in the Disruptive Prediction Algorithm

In embodiments, an AI algorithm is capable of generating discovery predictions that are most and least likely to be imagined by human scientists. The algorithm's mode of operation smoothly switches between these two extremes through an adjustable parameter β∈[−1,1]. The magnitude of β determines the amount of attention paid to familiarity/humanness (for β<0) or strangeness/alienness (for β>0) of the predictions against their plausibility, hence β=0 implies a human-neutral operation mode that gives full attention to plausibility. Moreover, it is desirable that the contribution from the two sources become equal when |β|=½, and that the output score varies continuously as β changes.

In embodiments, the algorithm combines two sources of information for measuring human availability and scientific plausibility, each of which separately scores the candidates. The two scores will then be combined through β to result in a single scalar score such that the above conditions are satisfied. The candidates are then sorted based on these final scores in increasing order and select k materials with the largest scores to output as predictions (k=50 in our experiments). The Shortest-Path distance (SP-d) between the materials and the properties in our hypergraph is computed to measure cognitive unavailability of their links, and use their semantic similarities based on a word embedding model to measure the likelihood of their links based on the existing literature. The word embedding model used was the skipgram Word2Vec model trained over literature from the most recent five-year window preceding the prediction year.

For any given candidate material x, denote its SP-d value and semantic similarity with respect to the property at consideration by sᵢ(x) and sᵢ(x), respectively. These scores have distinct units and vary in different scales, therefore a naive β-weighted averaging is inappropriate as it does not lead to equal contribution when |β|=½. Moreover, the SP-d values are unbounded as they can become arbitrarily large for entities disconnected from the property node in our hypergraph. As a result, Z-scores could not be directly applied either. Instead, a Van der Waerden transformation was applied to first standardize the scores. Suppose S is a set of scores and s(x)∈S, then its Van der Waerden transformation of x, denoted by \tilde{s}(x), is defined as

$$\tilde{s} ( x ) = φ ( \frac{r ( x )}{\vert S \vert + 1} )$$

where φ is the quantile function of the normal distribution, r(x) is the rank of s(x) within the set S and |S| denotes the cardinality of S. Once the signals are standardized through above transformation, they are normalized by computing their Z-scores, which are denoted by [symbol] (x) and [symbol] (x). Finally, the ultimate hybrid score to be used in the final ranking is computed by combining the standardized and normalized signals through the following β-weighted averaging:

s_{final}(x)=β [symbol] (x)+(1−|β|) [symbol] (x)

Note that when β<0, the algorithm tends to select materials with lower [symbol] (x), which in turn implies smaller SP-d and materials with more contextual familiarity in terms of their property. Alternatively, when β>0, the algorithm scores higher those materials that have greater SP-d hence more unfamiliar or alien predictions will result.

### Evaluating the Disruptive Prediction Algorithm

An ideal disruptive prediction algorithm generates discovery candidates that are complementary to those published by human scientists, i.e., unimaginable yet plausible candidates. Hence, running the disruptive AI at a certain prediction year y_{pred}, the majority of predictions are expected not to be discovered by human scientists in the following years. However, for the few cases that are actually discovered in reality, the average year of their discoveries tends to grow, thus becoming less imaginable to those at the present moment as disruptiveness (β) increases. In order to assess the full set of predictions that are dominated by undiscovered predictions for large ₁3 values, their scientific plausibility as the likelihood that they are potential disruptive discoveries is evaluated. For this purpose, the algorithm conservatively relies on the simulative and theoretical prior knowledge that exist in the field (see below). Specifically, while the percentage of predictions that become discovered after the prediction year sharply decays with β, the quality of the predictions remains high for longer. This observation, which we will measure by a criterion named the expectations gap, implies the existence of intervals of β where the disruptive AI approaches an ideal disruptive predictor by producing plausible undiscoverable predictions. Additionally, the joint probability of being plausible and undiscoverable is explicitly estimated at the same time to identify those intervals of β where the disruptive algorithm approaches the ideal operation point.

Expectation Gap—In embodiments, the goal is to define a single scalar score indicating whether our alien predictor is capable of generating unimaginable yet promising predictions. Two distributions over β are defined and conditioned on (i) discoverability and (ii) plausibility of predictions. The separation between these two distributions such that the latter is more concentrated on larger β values than the former will be the indicator, which will be quantified by the gap between their means (hence expectation gap).

For a fixed property and pool of candidate materials, denote the set of all materials that will be discovered after y_{pred}, by D and the set of all plausible materials by P. Also, let H_{β} and h_{β} be the full set of predictions and a randomly selected prediction generated by the disruptive algorithm operating with β, respectively. Precision of the algorithm in terms of identifying near-future discoveries is defined as Pr(h_{β}∈D|β) which can be simply computed by dividing the count of discoveries by the number of predictions: |H_{β}∩D|/|H_{β}|. Now using a uniform prior distribution over β, i.e., Pr(β)=const., and applying Bayes rule these precisions can be converted to Pr(β|h_{β}∈D by normalization across all β values such that they sum to unity.

Computing the second distribution is not as simple. The difficulty arises from the fact that the algorithm does not fully know P, instead it has one real-valued score per material characterizing the likelihood of its P-membership. These scores, denoted by τ, are obtained from field-related theoretical knowledge and first-principles laws (see next section). In the first step, the theoretical scores are transformed to probabilities, such that for every material x,τ=τ(x) goes to Pr(x∈P). Let τₘᵢₙ and τₘₐₓ be the global minimum and maximum of all the theoretical scores at hand. A monotonically increasing transformation T in the form of logit[tan(π(\hat{τ}−½+b)], where \hat{τ}=(τ−τₘᵢₙ)/(τₘₐₓ−τₘᵢₙ) is engineered such that
I. T(τₘᵢₙ)=0
II. T(τₘₐₓ)=1
III. T(τ_{mid})=½ where

$${τ}_{mid} = \frac{1}{\vert S \vert} {Σ}_{x ∈ D} τ ( x ) ,$$

which is the average of theoretical scores attributed to discovered materials. This condition uniquely specifies parameter b.

The resulting probabilities will be thresholded by ½ to probabilistically indicate which materials belong to P. Setting the midpoint as above is a direct consequence of the assumption that the majority of the materials discovered by the scientists to have the targeted properties are plausible findings, hence we take their average theoretical scores as a baseline and every material with a higher τ will also be considered as plausible. Such probabilistic classification of a material x to P is done with a confidence level proportional to the distance between the probability T(τ(x)) and the threshold ½. The confidence level of our decision regarding P-membership of sample x is

c(x)=T(τ(x)). if T(τ(x))≥½

c(x)=1−T(τ(x)), if T(τ(x))<½

Now, for any prediction set H_{β}, use weighted maximum likelihood estimation to compute the probability of being plausible given β:

$$Pr ( {h}_{β} ∈ P \vert β ) = {\sum }_{x ∈ {H}_{β} \text{:} T ( τ ( x ) ) \geq \frac{1}{2}} c ( x ) \text{/} {\sum }_{x ∈ {H}_{β}} c ( x )$$

Finally, similar to the previous case, the likelihood of β given plausibility, Pr(h_{β}∈P|β), can be obtained by simply normalizing these probabilities across all β values such that they sum to one.

The expectation gap is defined as the difference between the mean values of the two likelihoods described above:

ΔE[β]:=E[β|h_{β}∈P]−E[β|h_{β}∈D]

Having a positive gap suggests that theoretical plausibility is higher for more alien predictions than for those where the predictions are made and published. Therefore, because the discovery precision goes down with β, a positive expectation gap also means that there exists a non-empty gap when the alien algorithm approaches its ideal mission of human complementarity. Zero or negative gaps only occurred for a few human diseases.

Joint Probabilities—The expectation gap provides a single evaluation score for the performance of the alien prediction. However, it does not say anything about the desired range of β where the algorithm operates closest to its mission to serve complementary, high-value predictions. Here, to provide a clearer overview of the performance of our alien prediction for different β values, the algorithm directly models and calculates the probability that it outputs unfamiliar yet scientifically promising (plausible) predictions. As is also described above, unfamiliarity of a random prediction h_{β} means its unimaginability in context of the considered property and therefore its undiscoverability (i.e., h_{β}∉D). Thus, calculate the probability that h_{β} is unfamiliar and plausible given a certain β by the joint distribution Pr(h_{β}∉D, h_{β}∈P|β) Applying Bayes rule, this joint probability decomposes into two simpler distributions:

Pr(h_{β}∈D,h_{β}∈P|β)=Pr(h_{β}∈D|β)Pr(h_{β}∈P|β,h_{β}∈D)

where the first term in the right-hand-side is the complementary of discovery precision (i.e., 1−Pr(h_{β}∈D|β) and the second term can be computed similarly to the probability of plausibility, Pr(h_{β}∈P|β), described above, except that all computations are to be repeated on the predictions that are not discovered after the prediction year (h_{β}∈D), hence replacing H_{β} with 1−H_{β} when doing the weighted maximum likelihood above.

### Experiments with Deep Neural Networks

In embodiments, the DeepWalk method may be replaced with deeper graph convolutional neural networks.

Graph Neural Networks (GNNs) are used for learning low-dimensional graph representations or solving high-level tasks such as classification of graph nodes. They have a unique and efficient way of exploiting graph connectivities to propagate information between a central node and its neighborhood, an ability to incorporate feature vectors for nodes and/or edges, and a superior generalization to unseen (sub)graphs. Similar to DeepWalk, these models build a low-dimensional embedding space where graph-based similarities are preserved. However, unlike DeepWalk, they incorporate node feature vectors and directly utilize graph connectivities for message passing between nearby nodes when constructing the embedding space.

The embedding vector of a central node is constructed by sequentially processing messages passed from its local neighbors. There are numerous ways of aggregating the signals reaching out from neighbors. In embodiments, the algorithm uses the Graph Sample and Aggregate (GraphSAGE) platform, which applies the aggregations function on a subset of neighbors to avoid computational overhead. Let hᵢ^{l} denote the message from the i-th node in the l-th step of this sequential procedure. Then, the representation of the i-th node at the next level will be computed as

hᵢ^{l+1}=σ(f_{AGG}({hⱼ}˜_{jϵN(i)}Wᵢ

where f_{AGG} is an aggregation function (e.g., mean, pooling, etc.) applied on the concatenation of the local neighborhood's messages {hⱼ}˜_{jϵN(i)}, where N(i) is a subset of k₁ uniformly sampled nodes from the immediate neighbors of the i-th node N(i). The resulting aggregated messages will undergo a single-layer neural network parameterized by W₁ (the bias term is ignored for simplicity) and the non-linear activation σ. The input messages in the first step, i.e., hᵢ⁰∀i, are set to the provided node feature vectors. The final representation of the i-th node will be reached after L steps. The method used two steps (L=2) with samples sizes k₁=25 and k₂=10. It also used the mean aggregation function and applied the non-linearity through Rectified Linear Unit (ReLU) activation.

The unsupervised approach to the discovery prediction problem involves training a graph autoencoder, where the encoder component is modeled using the GraphSAGE architecture and the decoder component simply consists of a parameter-less inner-product of the encoder's output. This autoencoder is trained by minimizing a link-prediction loss function, which is approximated with negative sampling. The approximate loss has two parts accounting for the similarity of positive samples (pairs of nearby nodes) and the dissimilarity of negative samples (pairs of unconnected nodes). The mechanism of sampling positive and negative pairs closely resemble that which was used in the DeepWalk algorithm: the former is formed by pairing central/contextual nodes within windows sliding over short random walks, and the latter by means of sampling from the unigram distribution raised to power ¾ over the full set of nodes. Once the positive samples are drawn using sliding window size of 8, we begin minimizing the loss function in a mini-batch setting by iterating over pairs. A batch size of 1000, negative sampling size of 15 (per positive pair), learning rate of 5×10⁻⁶ and the Adam optimizer (21) with the default parameters are used.

The graph autoencoder is trained in two different settings: (i) using the full hypergraph, and (ii) after dropping author nodes. In both settings, only consider the material and property nodes are considered. In the full setting, the method takes account of author nodes at the time it draws positive samples and computes the adjacency matrix. In this setting the positive samples are drawn from DeepWalk sequences associated with α=1, whereas the experiment without authors use sequences corresponding to α→∞ so that no author nodes will be present in the random walk sequences. Moreover, connectivities between nodes are different for the two settings. In the author-less network, we connected two property or material nodes only if they appear in the same paper. In the full setting, we kept these connections and added more edges between nodes with at least one common author neighbor (even in the absence of papers in which they co-occur).

The above-discussion discusses generation of a hypergraph (e.g., FIGS. 1-5) and an extension of using that hypergraph to glean insights that have previously not been accessible. The ability to use the content and contexts nodes of the generated hypergraph, and then analyze certain analytical insights from that hypergraph provide an ability to quickly, and accurately study a plurality of documents representing a given corpus. These analytical insights allow a user to predict target variables that will be represented in future hypergraphs. Upon identification of selected content elements that will have a likelihood of discovery as represented in the future hypergraphs, the present systems and methods may implement a variety of actions in relation to these identified content elements. Using the hypergraph in this manner (and by including context) allows the systems and methods to perform more accurately, and also identify disruptive content elements that otherwise may not have been identified within the data itself unless represented within the presently described hypergraphs.

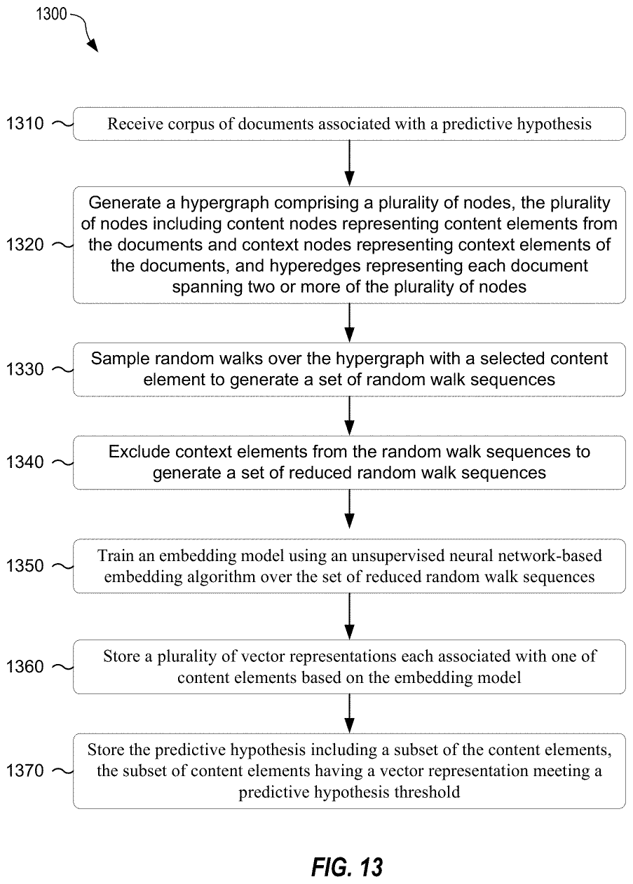

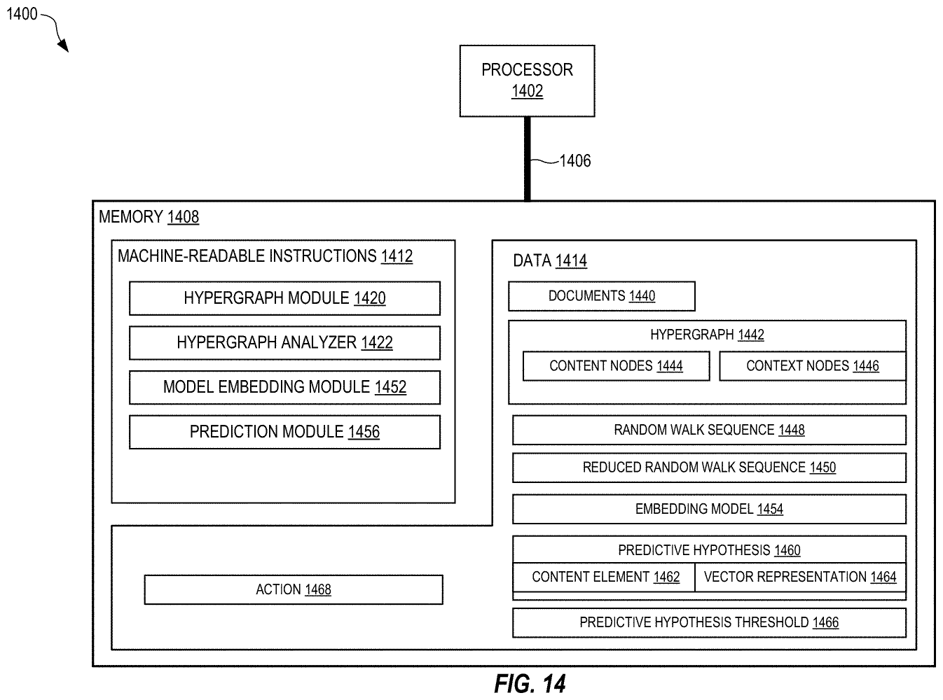

FIG. 13 is a flowchart of an example process 1300 for high-order modeling of predictive hypotheses. In some implementations, one or more process blocks of FIG. 13 may be performed by a device (e.g., device 1400 discussed below in FIG. 14). In some implementations, one or more process blocks of FIG. 13 may be performed by another device or a group of devices separate from or including the device.

As shown in FIG. 13, process 1300 may include receiving corpus of documents associated with a predictive hypothesis (block 1310). For example, where a predictive hypothesis is valuable electrochemical properties of thermoelectricity, ferroelectricity and photovoltaic capacity against a pool of 100K candidate compounds, the corpus includes a dataset of 1.5M scientific articles about inorganic materials, and future discoveries as a function of research publicly available to contemporary scientists. As another example, where a predictive hypothesis is repurposing of approximately 4K existing FDA-approved drugs to treat 100 important human diseases, the corpus includes the MEDLINE database of biomedical research publication. As another example, where the predictive hypothesis is predicting novel combination if ideas the corpus includes all granted patents within the US Patent database. As another example, where the predictive hypothesis is identifying newly started companies that will develop in a given technology field, the corpus of documents may include website descriptions of all companies (e.g., directly pulled from company websites, startup databases such as CrunchBase, or other company-descriptive databases) identifying as associated with the given technological field. Accordingly, the predictive hypothesis may be user-defined goals or targets to predicted.

As further shown in FIG. 13, process 1300 may include generating a hypergraph comprising a plurality of nodes, the plurality of nodes including content nodes representing content elements from the documents and context nodes representing context elements of the documents, and hyperedges representing each document spanning two or more of the plurality of nodes (block 1320). For example, a hypergraph may be generated comprising a plurality of nodes, the plurality of nodes including content nodes representing content elements from the documents and context nodes representing context elements of the documents, and hyperedges representing each document spanning two or more of the plurality of nodes, as described with respect to FIGS. 1-6, above.

As further shown in FIG. 13, process 1300 may include sampling random walks over the hypergraph with a selected content element to generate a set of random walk sequences (block 1330). For example, sample random walks may be made over the hypergraph with a selected content element to generate a set of random walk sequences, as described above with respect to FIG. 4 and FIG. 6, steps (D)-(E).

As further shown in FIG. 13, process 1300 may include excluding context elements from the random walk sequences to generate a set of reduced random walk sequences (block 1340). For example, the device may exclude context elements from the random walk sequences to generate a set of reduced random walk sequences, as described above with respect at least to FIG. 6 step (F).

As further shown in FIG. 13, process 1300 may include training an embedding model using an unsupervised neural network-based embedding algorithm over the set of reduced random walk sequences (block 1350). For example, an embedding model may be trained using an unsupervised neural network-based embedding algorithm over the set of reduced random walk sequences, as described above with respect to FIG. 6 steps (F) and (G).

As further shown in FIG. 13, process 1300 may include storing a plurality of vector representations each associated with one of content elements based on the embedding model (block 1360). For example, vector representations of content elements may be stored based on the embedding model, as described above with respect to FIG. 6 step (G).

As further shown in FIG. 13, process 1300 may include storing the predictive hypothesis including a subset of the content elements, the subset of content elements having a vector representation meeting a predictive hypothesis threshold (block 1370). For example, the predictive hypothesis may be stored, the predictive hypothesis including a subset of the content elements, the subset of content elements having a vector representation meeting a predictive hypothesis threshold, as described above with respect to FIG. 6 step (E). In an embodiment, the predictive hypothesis threshold is a threshold number of the content elements in a rank-ordered list. In an embodiment, the predictive hypothesis threshold is any number of content elements meeting a threshold discovery likelihood value.

Storing the predictive hypothesis (block 1370) may further using a disruptive prediction algorithm, such as that described above with respect to FIGS. 10-12, to score, rank, and select the subset of content nodes. Selection of the subset of content nodes may include analyzing one or both of expectation gap and joint probabilities as discussed above. Accordingly, any feature described above with respect to disruptiveness may be applied to method 1300, without departing from the scope hereof

The predictive hypothesis may then be acted on. A given action implemented will differ depending on the given predictive hypothesis. In one example, a system may utilize the predictive hypothesis to automatically filter input invention disclosures. An entity may have an invention disclosure repository. Each invention disclosure within the invention disclosure repository may be analyzed to generate a feature representation of that disclosure that is comparable to the vector representations within the predictive hypothesis (e.g., by implementing one or more NLP embedding models). Said feature representation may then be compared to the predictive hypothesis. The invention disclosure may be automatically discarded when the invention disclosure does not match one or more aspects of the predictive hypothesis. As discussed above, the hypergraphs identify those inventions that will result in granted patents, but also those inventions that may be considered as disruptive. By comparing each input to a predictive hypothesis that identifies novel and/or disruptive granted inventions, the entity can automatically weed out potentially invaluable invention disclosures. Similarly, the predictive hypothesis, and the similarity of an invention disclosure to one or more of the content elements identified within the predictive hypothesis can be used to automatically prioritize certain ones of the invention disclosure elements (such as automatically setting filing procedures, and/or outputting a ranked order in which the invention disclosures are to be converted into patent applications for filing).

As another example of utilizing the predictive hypothesis in an automated action, the predictive hypothesis may be identifying investment opportunities over a corpus of potentially investable entities. The investing entity may have a pre-defined investment amount. The predictive hypothesis may be used to distribute, and in certain instances automatically initiate investment, in one or more identified companies. The distribution and/or automatic investment may be balanced between multiple ones of the identified content elements of the hypergraph to balance the investment risk. Because the hypergraph and resulting predictive hypothesis identifies a plurality of companies that each have a likelihood of success in success, by distributing the investment over the top X companies in a ranked-order of the subset of content nodes identified in the predictive hypothesis, the investment of the pre-defined investment amount is balanced and risk is reduced.

Process 1300 may include additional implementations, such as any single implementation or any combination of implementations described below and/or in connection with one or more other processes described elsewhere herein.

Although FIG. 13 shows example blocks of process 1300, in some implementations, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 shows a system 1400 for high-order modeling of predictive hypotheses, in embodiments. System 1400 may be combined with system 500, without departing from the scope hereof. System 1400 may implement any of the above-discussed functionality with respect to FIGS. 6-13, and if included with system 500, also FIGS. 1-4. The system 1400 is a computing system in which a memory 1408 is communicably coupled to a processor 1402 over a bus 1406. The processor 1402 may be any type of circuit or chip capable of performing logic, control, and input/output operations. For example, the processor 1402 may include one or more of a microprocessor with one or more central processing unit (CPU) cores, a graphics processing unit (GPU), a digital signal processor (DSP), a field-programmable gate array (FPGA), a system-on-chip (SoC), and a microcontroller unit (MCU). The processor 1402 may also include a memory controller, bus controller, and other components that manage data flow between the processor 1402, memory 1408, and other devices connected to the bus 1406.

The memory 1408 stores machine-readable instructions 1412 that, when executed by the processor 1402 control the system 1400 to implement the functionality and methods described above. The functionality of memory 1408 may alternatively or additionally be implemented by circuit or chip capable of performing logic, control, and input/output operations implemented by one or more of the module shown with respect to memory 1408 (such as an FPGA configured to implement any of the functionality of the system 1400). The memory 1408 also stores data 1414 used by the processor 1402 when executing the machine-readable instructions 1412. In the example of FIG. 14, the machine-readable instructions 1412 include a hypergraph module 1420 that generates hypergraphs from a corpus of documents 1440 associated with a predictive hypothesis. Received documents 1440 may be pre-processed using one or more natural language processing models to embed the text within the documents into an embedded space for analysis, and generates a hypergraph 1442 having a plurality of content nodes 1444 representing content elements from the documents, context nodes 1446 representing context elements of the documents, and hyperedges 1448 representing each document spanning two or more of the plurality of nodes. Generation of hypergraph 1442 may use any one or more of the features discussed with respect to FIGS. 1-5. System 1400 may include a hypergraph analyzer 1422 that samples random walks over the hypergraph 1442 with a selected content element to generate a set of random walk sequences 1448. Hypergraph analyzer 1422 may exclude context elements from the random walk sequences to generate list of reduced random walk sequences 1450.

System 1400 may include a model embedding module 1452 that trains an embedding model 1454 using an unsupervised neural network-based embedding algorithm over the set of reduced random walk sequences 1450.

System 1400 may include a prediction module 1456 that identifies and/or stores a plurality of vector representations 1458 each associated with one of content elements based on the embedding model 1454. The prediction module 1456 may then generate and/or store a predictive hypothesis 1460 including a subset of the content elements 1462, each content element of the subset of content elements having a vector representation 1464 meeting a predictive hypothesis threshold 1466.

The prediction module 1456 may use a disruptive prediction algorithm, such as that described above with respect to FIGS. 10-12, to score, rank, and select the subset of content nodes 1462. Selection of the subset of content nodes may include analyzing one or both of expectation gap and joint probabilities as discussed above.

The prediction module 1456 may further implement an action 1468 based on the predictive hypothesis 1460. A given action implemented will differ depending on the given predictive hypothesis 1460. In one example, system 1400 may utilize the predictive hypothesis 1460 to automatically filter input invention disclosures that are stored within data 1414. An entity may have an invention disclosure repository within data 1414. Each invention disclosure within the invention disclosure repository may be analyzed to generate a feature representation of that disclosure that is comparable to the vector representations within the predictive hypothesis (e.g., by implementing one or more NLP embedding models). Said feature representation may then be compared to the predictive hypothesis 1460. The invention disclosure may be automatically discarded (e.g., action 1468) when the invention disclosure does not match one or more aspects of the predictive hypothesis. As discussed above, the hypergraphs identify those inventions that will result in granted patents, but also those inventions that may be considered as disruptive. By comparing each input to a predictive hypothesis that identifies novel and/or disruptive granted inventions, the entity can automatically weed out potentially invaluable invention disclosures. Similarly, the predictive hypothesis, and the similarity of an invention disclosure to one or more of the content elements identified within the predictive hypothesis can be used to automatically prioritize certain ones of the invention disclosure elements (such as automatically setting filing procedures, and/or outputting a ranked order in which the invention disclosures are to be converted into patent applications for filing).

As another example of utilizing the predictive hypothesis 1460 in an automated action 1468, the predictive hypothesis 1460 may be identifying investment opportunities over a corpus of potentially investable entities. The investing entity may have a pre-defined investment amount defined within data 1414. The predictive hypothesis 1460 may be used to distribute, and in certain instances automatically initiate investment, in one or more identified companies. The distribution and/or automatic investment may be balanced between multiple ones of the identified content elements of the hypergraph to balance the investment risk. Because the hypergraph and resulting predictive hypothesis 1460 identifies a plurality of companies that each have a likelihood of success in success, by distributing the investment (e.g., action 1468) over the top X companies in a ranked-order of the subset of content nodes identified in the predictive hypothesis, the investment of the pre-defined investment amount is balanced and risk is reduced.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A computer-implemented method for high-order modeling of predictive hypotheses, comprising:
receiving corpus of documents associated with a predictive hypothesis;
generating a hypergraph comprising a plurality of nodes, the plurality of nodes including content nodes representing content elements from the documents and context nodes representing context elements of the documents, and hyperedges representing each document spanning two or more of the plurality of nodes;
sampling random walks over the hypergraph with a selected content element to generate a set of random walk sequences;
excluding context elements from the random walk sequences to generate a set of reduced random walk sequences;
training an embedding model using an unsupervised neural network-based embedding algorithm over the set of reduced random walk sequences;
storing a plurality of vector representations each associated with one of content elements based on the embedding model; and
storing the predictive hypothesis including a subset of the content elements, each content element of the subset of content elements having a vector representation meeting a predictive hypothesis threshold.

2. The method of claim 1, wherein sampling random walks further comprises:
a) randomly selecting a first document with an identified content element;
b) randomly selecting a different content element or a context element of the first document;
c) randomly selecting a second document containing the content element or context element selected in b); and
d) repeating steps b)-c) until a defined number of steps is reached or no documents containing the selected content or context element are available.

3. The method of claim 2, wherein sampling random walks is based on a non-uniform node sampling distribution.

4. The method of claim 1, wherein content elements are based on materials and properties of materials.

5. The method of claim 1, wherein context elements are based on journals, conferences, and authors.

6. The method of claim 1, wherein the content elements are based a plurality of companies and the context elements are based on individuals associated with the companies.

7. A method for high-order stochastic block modeling, comprising:
training a sequence of T hypergraph generators using a corresponding sequence of T training hypergraphs G¹, . . . , G^{T}, the i^{th} hypergraph generator of the sequence of T hypergraph generators having n generator parameters Θⁱ=(\vec{θ}₁⁽ⁱ⁾, . . . , \vec{θ}ₙ⁽ⁱ⁾) corresponding to n nodes of the sequence of T training hypergraphs, said training comprising:
iteratively updating the generator parameters Θⁱ of each of the T hypergraph generators to maximize a global probability
$$P ( {G}^{1} , … , {G}^{T} \vert {Θ}^{1} , … , {Θ}^{T} ) = P ( {G}^{1} \vert {Θ}^{1} ) {\prod }_{i = 2}^{T} P ( {Θ}^{i} \vert {Θ}^{i - 1} ) P ( {G}^{i} \vert {Θ}^{i} ) ;$$
wherein:
i=1, . . . , T is an index;
P(Gⁱ|Θⁱ) is a single-hypergraph probability that the i^{th} hypergraph generator will generate the training hypergraph Gⁱ based on the generator parameters Θⁱ; and
P(Θⁱ|Θⁱ⁻¹) is a transition probability linking sequentially neighboring hypergraph generators of the sequence of T hypergraph generators; and
generating a next hypergraph G^{T+1} based on the generator parameters Θ^{T} of the last hypergraph generator of the sequence of T hypergraph generators.

8. The method of claim 7, further comprising outputting the next hypergraph G^{T+1}.

9. The method of claim 7, further comprising determining, based on the next hypergraph G^{T+1}, a novelty score s for at least one combination h of nodes according to
$$s ( h ) = - log {\sum }_{d = 1}^{N} {Π}_{j ∈ h} {θ}_{j , d}^{( T + 1 )} ;$$
wherein:
j is an index over each node of the combination h of nodes;
d is an index over N dimensions of a latent vector space; and
the generator parameters \vec{θ}ⱼ^{(T+1)}=(θ_{j,1}^{(T+1)}, θ_{j,2}^{(T+1)}, . . . , θ_{j,N}^{(T+1)}) represent a location of the node j in the latent vector space such that θ_{j,d}^{(T+1)} represents a probability that the node j belongs to the d^{th} dimension of the latent vector space.

10. The method of claim 9, further comprising outputting the novelty score s.

11. The method of claim 7, further comprising determining each single-hypergraph probability P(Gⁱ|Θⁱ) by:
obtaining, from the training hypergraph Gⁱ, a number xₕ of observed hyperedges joining each combination h of nodes; and
calculating said each single-hypergraph probability according to
$$P ( {G}^{i} \vert {Θ}^{i} ) = {Π}_{h ∈ H} P ( {x}_{h} \vert {Θ}^{i} ) ;$$
wherein:
h is an index over a set H of combinations of the n nodes; and
P(xₕ|Θⁱ) is a node-combination probability, based on the generator parameters Θⁱ, of observing xₕ hyperedges in the training hypergraph Gⁱ for the combination h of nodes.

12. The method of claim 11, wherein the set H includes each combinations of nodes having a number of nodes less than or equal to a largest number of nodes joined by a hyperedge in the training hypergraph Gⁱ.

13. The method of claim 11, further comprising determining each node-combination probability P(xₕ|Θⁱ) from a Poisson distribution characterized by a mean
$${λ}_{h} = {\sum }_{d = 1}^{N} {Π}_{j ∈ h} {θ}_{j , d}^{( i )} ;$$
wherein:
j is an index over each node of the combination h of nodes;
d is an index over N dimensions of a latent vector space;
the generator parameters \vec{θ}ⱼ⁽ⁱ⁾=(θ_{j,1}⁽ⁱ⁾, θ_{j,2}⁽ⁱ⁾, . . . , θ_{j,N}⁽ⁱ⁾) represent a location of the node j in the latent vector space such that θ_{j,d}⁽ⁱ⁾ represents a probability that the node j belongs to the d^{th} dimension of the latent vector space; and
the mean λₕ represents the probability that all of the nodes of the combination h load on the same dimensions.

14. The method of claim 7, wherein:
each of the T hypergraph generators includes additional parameters Rⁱ=(r₁⁽ⁱ⁾, r₂⁽ⁱ⁾, . . . , rₙ⁽ⁱ⁾) corresponding to the n nodes, the additional parameters R ti being iteratively updated during said training;
the mean λₕ is given by
$${λ}_{h} = {\sum }_{d = 1}^{N} {Π}_{j ∈ h} {θ}_{j , d}^{( i )} \times {Π}_{j ∈ h} {r}_{j}^{( i )} ;$$
and
each transition probability is given by
P(Θⁱ,Rⁱ|Θⁱ⁻¹,Rⁱ⁻¹)

15. The method of claim 7, further comprising determining each transition probability P(Θⁱ|Θⁱ⁻¹) is randomly selected from a multi-dimensional Gaussian probability density centered at Θⁱ.

16. The method of claim 7 wherein said training uses stochastic gradient ascent.

17. The method of claim 7, wherein said training includes negative sampling.

18. A system for high-order stochastic block modeling, comprising:
a processor:
a memory in electronic communication with the processor, the memory storing:
a sequence of T training hypergraphs G¹, . . . , G^{T} having n nodes; and
a sequence of T hypergraph generators, the i^{th} hypergraph generator of the sequence of T hypergraph generators having n generator parameters Θⁱ=(\vec{θ}₁⁽ⁱ⁾, . . . , \vec{θ}ₙ⁽ⁱ⁾) corresponding to the n nodes; and
a training module, implemented as machine-readable instructions stored in the memory, that, when executed by the processor, controls the system to iteratively update the generator parameters Θⁱ of each of the T hypergraph generators to maximize a global probability
$$P ( {G}^{1} , … , {G}^{T} \vert {Θ}^{1} , … , {Θ}^{T} ) = P ( {G}^{1} \vert {Θ}^{1} ) {\prod }_{i = 2}^{T} P ( {Θ}^{i} \vert {Θ}^{i - 1} ) P ( {G}^{i} \vert {Θ}^{i} ) ;$$
wherein:
i=1, . . . , T is an index;
P(Gⁱ|Θⁱ) is a single-hypergraph probability that the i^{th} hypergraph generator will generate the training hypergraph Gⁱ based on the generator parameters Θⁱ; and
P(Θⁱ|Θⁱ⁻¹) is a transition probability linking sequentially neighboring hypergraph generators of the sequence of T hypergraph generators; and
a prediction module, implemented as machine-readable instructions stored in the memory, that, when executed by the processor, controls the system to generate a next hypergraph G^{T+1} based on the generator parameters Θ^{T} of the last hypergraph generator of the sequence of T hypergraph generators.
